(19) United States
(12) Patent Application Publication
(10) Pub. No.: US 2006/0106852 A1
(43) Pub. Date: May 18, 2006

(54) Automated storage management of files, including computer-readable files

(75) Inventors: Michael Eric Siddall, West Chester, PA (US); Jack Burk Goldman, Brookline, MA (US); John Francis Coughlan, Buzzards Bay, MA (US); Arthur Charles Fitzgerald, West Peabody, MA (US)

Correspondence Address: WOLF GREENFIELD & SACKS, PC;FEDERAL RESERVE PLAZA, 600 ATLANTIC AVENUE, BOSTON, MA, 02210-2206, US

(73) Assignee: Iron Mountain Incorporated, Boston, MA (US)

(21) Appl. No.: 11/271,193

(22) Filed: Nov. 11, 2005

Related U.S. Application Data
(63) Continuation-in-part of application No. 10/849,284, filed on May 19, 2004.
Application No. 10/849,284 is a continuation of application No. 09/901,220, filed on Jul. 9, 2001, now Pat. No. 6,758,802.
Application No. 09/901,220 is a continuation of application No. 09/189,772, filed on Nov. 10, 1998, now Pat. No. 6,260,049.

(51) Int. Cl. G06F 7/00

(52) U.S. Cl. 707/101

(57) ABSTRACT

Automated systems and processes for managing paper and/or digital files, particularly medical records contained in digital files, digital or paper file folders and the like, in a file storage system having a finite size or expansion capacity. For paper files, a system tracks the thickness of individual file folders, the capacity of storage shelf sections, and the percentage of free space remaining in each shelf section. When occupied shelf space exceeds a threshold percentage for a shelf section, file folders are purged according to the likelihood that certain files will not be requested in the future, by applying purging algorithms to the files. For digital files, when a cumulative amount of storage space consumed by digital files reaches a certain threshold, typically less than the capacity, digital files are purged from the storage allocation according to an algorithm assessing a likelihood that certain files will not be requested in the future.

### RELATED APPLICATIONS

This application is a continuation-in-part (CIP) of U.S. patent application Ser. No. 10/849,284, titled Automated Shelf Management System And Process For Tracking And Purging File Folders In A File Storage Facility, filed on May 19, 2004, which is a continuation of U.S. patent application Ser. No. 09/901,220, titled Automated Shelf Management System And Process For Tracking And Purging File Folders In A File Storage Facility, filed on Jul. 9, 2001, now U.S. Pat. No. 6,758,802, which is a continuation of U.S. patent application Ser. No. 09/189,772, titled Automated Shelf Management System And Process For Tracking And Purging File Folders In A File Storage Facility, filed on Nov. 10, 1998, now U.S. Pat. No. 6,260,049, wherein each of these applications is hereby incorporated by reference in its entirety.

### FIELD

The present invention relates generally to an automated system and process for tracking paper files, electronic files, and the like, and more particularly to an automatic system and process for tracking and purging files in a paper or an electronic file storage system having predetermined or limited expansion capacity.

### BACKGROUND

In office environments, although there is a trend toward the paperless office, where files will exist primarily in electronic form, there is continued reliance on paper files and paper file folders, which are generally stored on open shelving units or in filing cabinet drawers. In some environments, such as health care, legal, insurance, and corporate, the number of files and the contents of those files can quickly grow to exceed the capacity of most file systems and the space available for file storage.

The problems of storage and tracking of individual files have generally been addressed by improving the physical storage shelving to make it more compact or to provide some automatic means of file retrieval. For example, U.S. Pat. No. 4,219,296 discloses an automatic file storage and retrieval apparatus, in which a movable carriage locates and pulls out individual files stored on coded shelving. Although systems like the one described are basically effective, they are expensive and they have a limited capacity. Also, file folders which are inactive and not likely to be needed take up valuable file storage space.

Some large businesses have addressed their growing file storage needs by allocating greater space within their buildings to the file storage function, and even constructing additional buildings for file storage; however this is generally an expensive solution, requiring high construction costs as well as operating and staffing costs.

Another solution has been to move the paper files that will not be needed to an off-site storage facility, where the files are stored on shelving or in cataloged boxes and the like. For example, a typical medical records storage facility associated with a large city hospital might typically include as many as one million patient files, with 450,000 patient files on-site and the remainder in off-site storage. A file can be retrieved from off-site storage when needed by a system of delivery vehicles or other means. The drawback of this method is that retrieval takes time; often there is a delay of several hours or days between the time the recognition is made to retrieve a file and the time the file is received. Also, there is a high cost associated with storage and retrieval of records stored off-site.

Furthermore, there is a problem in classifying which files should be kept on site in primary storage and which files should be sent to the off-site storage facility. This problem has generally been addressed by having a single purging criteria applied to all the files as a whole. Such a purging criteria might be, for example, to remove all files older than a certain cut-off date, the logic being that older files would most likely not be needed for current referrals. Purging criteria based on cut-off dates does not address the common situation in which files older than an arbitrary cut-off date are still needed for various reasons and will need to be retrieved from off-site storage, incurring time delays and high costs.

Another common drawback of conventional filing systems is file section overflow, in which individual filing sections may become overfilled. This results from some file sections filling at a faster rate than other file sections due to an increase in the number of files or an increase in the thickness of individual files due to added content. In these situations, in order to make adequate room for new files within overfilled file sections, a manual process known as back shifting is performed, in which the file contents for several shelf sections are redistributed to make more room in the overfilled sections. Back shifting is a time-consuming, tedious process, which can cause delays in normal filing operations during the time the back shifting is carried out.

Similar drawbacks exist for electronic filing systems in which electronic files are stored on computer-readable media. Although computer-readable media typically takes up far less space than paper files, there typically is a limit to the amount of storage space available on given media. Just as there is a relationship between the weight of a piece of paper and the physical shelf space required to store it, there is also a relationship between the characters typed or written on a digital page and the amount of disk space required to store it. For example, a typical ASCII page contains 2 k bits of data. Further, a printed version of that same page, printed, then scanned into a computer to create a compressed bit map image, would increase the 2 k bit ASCII page to roughly 24 k bits at 200 bits per inch.

With the growing use of digital imaging in the medical care industry, in particular Radiology (e.g., capturing an X-ray scan, magnetic resonance imaging (MRI) scan, computerized tomography (CT or CAT) scan, etc., on a computer-readable medium), the amount of storage space consumed by electronic files is a growing problem, often challenging the limits of storage space available. For example, one or more (e.g., an array) of storage devices (e.g., disks and/or tapes) on a communications network, and/or portions thereof, of some finite storage capacity may be allocated for use by a particular medical care unit such as, for example, a radiology center, a medical care enterprise, center, facility, department, ward, floor, clinic, office, other type of medical care unit, or any combination of the foregoing. As used herein, a “storage allocation” is the portion of one or more computer-readable media (e.g., of a storage array or otherwise) that has been allocated for use by a particular medical care unit, and “storage capacity” is a capacity of storage space (e.g., memory) available on the storage allocation.

Similar to the problems discussed above with respect to paper storage, when the amount of space consumed by a group of electronic files approaches a storage capacity of a storage allocation, there is a problem in determining which electronic files should be kept within the storage allocation, and which electronic files should be archived outside of the storage allocation such as, for example: as part of a separate storage allocation; as part of a separate network or sub-network; at a different physical location; as part of storage served by a separate server; in another storage arrangement; or any combination of the foregoing. This problem has generally been addressed by: simply adding additional electronic storage as demand rises, a user manually selecting which electronic files should be purged or archived, or by having a single generic purging or archiving criteria automatically applied to all the electronic files as a whole. Such a purging criteria might be, for example, to remove all electronic files older than a certain cut-off date. However, purging criteria based on cut-off dates does not address the common situation in which electronic files older than an arbitrary cut-off date are still needed for various reasons and will need to be retrieved from outside a storage allocation, which typically incurs high costs and/or time delays that affect patient care.

Another problem in managing paper files is how to effectively deal with pending requests and multiple pending requests. Oftentimes, an individual file will be requested by several users simultaneously. For example, in the medical field, a new patient's file will need to be seen by doctors in various medical departments, such as radiology and pathology, as well as administrative departments, such as patient billing. In conventional filing systems, pending file requests are handled by hand-written routing slips, and files are often not re-routed until they are returned to the file shelves. Most existing filing systems do not have a way to deal effectively with routing the requested file to the various users in a time-efficient manner to minimize delays-potentially impacting the quality of patient care.

The present invention overcomes the disadvantages of known filing systems.

### SUMMARY

A solution to the problems of prior file storage systems is provided by embodiments of the present invention. For paper files, this solution may involve optimizing the use of available file space by seeking to keep the shelves full or at a predetermined percentage of being full, such as, for example, 90-95 percent full, while avoiding the problems associated with overfilled files and back shifting. For digital files (i.e., electronic or photonic files), the solution may involve maintaining the amount of storage space consumed by the digital files at or below a predetermined threshold, which may be a particular percentage of the storage capacity such as, for example, 90-95%.

In some embodiments of the invention, a computerized file tracking and purging system is provided, which seeks to keep most file sections in a file storage facility nearly full but never overflowing.

In some embodiments, a computerized file tracking and purging system is provided, which keeps those records which are deemed to be most active within the storage facility and removes or purges the inactive files to off-site or distant storage.

In some embodiments, a computerized file tracking and purging system is provided, which determines for each file section, hierarchically, which files are most likely to be requested and which files are least likely to be requested.

In some embodiments, a system and/or method is provided for keeping an amount of storage space consumed by digital files within a storage allocation near a storage capacity, and not allowing the amount of consumed space to reach or exceed the storage capacity.

In some embodiments, a system and/or method is provided, which keeps within a storage allocation those digital files deemed most active within the storage allocation, and which removes (e.g., archives) from the storage allocation those digital files determined to be inactive.

In some embodiments, a system and/or method is provided for determining, in a hierarchical fashion (e.g., in multiple phases), which digital files are most likely to be requested by a user (e.g., a health care professional), and/or which digital files are least likely to be requested.

In some embodiments of the invention, given limitations in digital storage space and practicalities involved in maintaining large digital files, it is often necessary to make a compromise between available disk space and speed of access.

Some embodiments of the invention address the results of studies that have shown that, in the medical field, the most accessed data, whether in physical or digital form, is typically that belonging to the chronically ill. This data typically is accessed at a substantially higher rate than information on patients that are in relative good health and/or come to a health care facility for episodic events.

In some embodiments, a system is employed that uses intelligent algorithms based on probabilities of future access requirements of data (e.g., regardless of format) as the driving force in determining where to store data and how it is to be accessed. The fundamental purpose of such an algorithm may be to enable fulfillment of a highest percentage of future requests for information (e.g., in the form of paper and/or digital files) stored locally while limiting the number of requests from off-site, whether the offsite storage were an archival remote warehouse or an archival remote digital storage farm.

There are several different types of digital storage available today, including magnetic tape, magnetic disk, optical disk, semiconductor memory (e.g., a variety of forms of ROM such as flash memory and others). There is a cost associated with each of these types of storage, and this cost may vary for each type depending on several factors such as, for example: its size; its configuration; the management of the storage; how information is being stored to it; the size of information being stored to it; the distance between the storage and the one or more computers using the storage; the connectivity to/from the storage (which includes several factors in itself), and other factors.

In embodiments of the invention in which purging digital files involves archiving and/or storing them offsite, the cost of using one or more types of storage is considered in determining which digital files to purge and/or where to move (e.g., archive) the purged digital files. For example, for each purging event, digital files may be stored in a fashion most economical for the purging event.

In some embodiments of the invention, storing one or more digital files in the storage allocation from which they are purged is more expensive than storing them in a storage to which they are moved. That is, the purged files are moved to cheaper storage in some embodiments.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

In the drawings:

FIG. 1 is a block diagram illustrating an example of a shelf manager system within an operating environment, according to some embodiments of the invention;

FIG. 2 is a block diagram illustrating an example of an active file storage shelving configuration, according to some embodiments of the invention;

FIG. 3 is a block diagram illustrating an example of a medical file folder and its component parts, according to some embodiments of the invention;

FIG. 4 is a block diagram illustrating an example of another active file storage shelving configuration, according to some embodiments of the invention;

FIG. 5 illustrates an example of a personal computer system, which may be used to implement some embodiments of the invention;

FIG. 6 is a block diagram illustrating an example of the internal components of the computer system shown in FIG. 5;

FIG. 7 is a block diagram illustrating an example of a logging station and its various components, according to some embodiments of the invention;

FIG. 8 illustrates an example of multiple logging station incorporating a database server as part of a local area network, according to some embodiments of the invention;

FIG. 9 illustrates an example of a graphical user interface screen for a main menu, according to some embodiments of the invention;

FIG. 10a-10b comprise a flowchart illustrating an example of a main menu function, according to some embodiments of the invention;

FIG. 11 illustrates an example of a graphical user interface screen for a scan folders subroutine, according to some embodiments of the invention;

FIG. 12a-12e comprise a flowchart illustrating an example of a scan folders subroutine, according to some embodiments of the invention;

FIG. 13A is a flowchart illustrating an example of a file purging subroutine, according to some embodiments of the invention;

FIG. 13B is a flowchart illustrating an example of a method of purging digital files from a storage allocation, according to some embodiments of the invention;

FIG. 14a-14c comprise a flowchart illustrating an example of a file purging subroutine, according to some embodiments of the invention;

FIG. 15 illustrates an example of a graphical user interface screen for a pending requests subroutine, according to some embodiments of the invention;

FIG. 16 is a flowchart illustrating an example of a pending requests subroutine, according to some embodiments of the invention;

FIG. 17 illustrates an example of a graphical user interface screen for a folders master subroutine showing a folders add dialogue box screen, according to some embodiments of the invention;

FIG. 18 illustrates an example of a graphical user interface screen for a folders master subroutine showing a folders search dialogue box screen, according to some embodiments of the invention;

FIG. 19 is a flowchart illustrating an example of a folders master subroutine, according to some embodiments of the invention;

FIG. 20 illustrates an example of a graphical user interface screen for a login/logout history subroutine, according to some embodiments of the invention;

FIG. 21 is a flowchart illustrating an example a login/logout history subroutine, according to some embodiments of the invention;

FIG. 22 illustrates an example of a graphical user interface screen for a shelf space subroutine, according to some embodiments of the invention;

FIG. 23 is an example of a flowchart of the shelf space subroutine, according to some embodiments of the invention;

FIG. 24a-24h illustrate examples of graphical user interface screens for a print reports subroutine, according to some embodiments of the invention;

FIG. 25 is a flowchart illustrating an example of a print reports subroutine, according to some embodiments of the invention;

FIG. 26 illustrates an example of a graphical user interface screen for the appointments function, according to some embodiments of the invention;

FIG. 27 is a flowchart illustrating an example of an appointments function, according to some embodiments of the invention;

FIG. 28 illustrates an example of an audit system graphical user interface screen, according to some embodiments of the invention;

FIG. 29 is a flowchart illustrating an example of an audit system subroutine, according to some embodiments of the invention;

FIG. 30 illustrates an example of a graphical user interface screen for a remote scans subroutine, according to some embodiments of the invention;

FIG. 31 is a flowchart illustrating an example of a remote scans subroutine, according to some embodiments of the invention;

FIG. 32 is a flowchart illustrating an example of a measure shelves subroutine, according to some embodiments of the invention;

FIG. 33 illustrates an example of a graphical user interface screen for an add employees subroutine, according to some embodiments of the invention;

FIG. 34 is a flowchart illustrating an example of an add employees subroutine, according to some embodiments of the invention;

FIG. 35 illustrates an example of a graphical user interface screen for an add locations subroutine, according to some embodiments of the invention;

FIG. 36 is a flowchart illustrating an example of an add locations subroutine, according to some embodiments of the invention;

FIG. 37 illustrates an example of a graphical user interface screen for a system setup subroutine, according to some embodiments of the invention;

FIG. 38 is a flowchart illustrating an example of a system setup subroutine, according to some embodiments of the invention;

FIG. 39 illustrates an example of a graphical user interface screen for a compress files subroutine, according to some embodiments of the invention;

FIG. 40 is a flowchart illustrating an example of a compress files subroutine function, according to some embodiments of the invention;

FIG. 41 illustrates the graphical user interface screen for tracking and purging x-ray film jackets, according to some embodiments of the invention;

FIG. 42 is a block diagram illustrating an example of a system employing intelligent imaging, according to some embodiments of the invention;

FIG. 43 is a block diagram illustrating an example system employing radio frequency identification and tracking of files, according to some embodiments of the invention; and

FIG. 44 is a block diagram illustrating an example of a system employing on-demand file creation, according to some embodiments of the invention.

### DETAILED DESCRIPTION

Although several embodiments of the invention are described herein primarily in relation to paper filing systems, it should be appreciated that the invention is not so limited. Some of these embodiments and/or aspects thereof may be implemented for digital files, and the scope of the invention is intended to cover such implementations. Thus, embodiments of the invention that discuss file folders being stored in a file room or file storage facility, or a section thereof, may be applied, as appropriate, to digital files being stored within a storage allocation. For example, instead of determining the thickness of individual paper file folders, adding the thicknesses of these paper file folders to produce a total thickness, and determining whether the total thickness exceeds a threshold, in some embodiments of the invention the size of (i.e., the amount of memory consumed by) individual digital files are determined, the sizes of the digital files are added together to produce a cumulative amount of consumed memory and the cumulative amount of memory is compared to a threshold value.

As used herein, the term “digital file” includes in scope electronic files (i.e., files implemented using electrical signals) and photonic files (i.e., files implemented using photonic signals—light). Although electronic files are the type of digital files predominantly (if not exclusively) in use today, it is contemplated that photonic technology may be developed to the point where photonic files may be used to implement embodiments of the invention. Digital files may include and/or represent any of a variety of types of information, including binary information, text, images (e.g., X-ray scans, MRIs, CT or CAT scans), audio, video, other types of information, and any combination of the foregoing, and may be formatted in accordance with any of a variety of technologies, including Picture Archiving & Communications System (PACS), ASCII, PDF, JPEG, MPEG, MP3, XML, other formats, or any suitable combination of the foregoing, to name just a few.

A computer-implemented shelf manager system may be provided for tracking, file maintenance, and file purging in health care, government, legal and other record-intensive environments. Such a system may be applicable to file storage situations such as open shelves, mobile shelves, or mechanical shelving systems--wherever there is a desire to prevent the size of individual file folders from growing beyond the capacity of fixed-capacity shelves. An automated system and process may be provided for managing paper files, such as medical records contained in file folders and the like, in a file storage system having a predetermined size or limited expansion capacity.

In some embodiments, a filing method known as terminal digit filing may be employed, in which a file room or file storage facility is divided in a basically equal number of sections. Each file folder may be assigned a unique file identifier, which links it to the section in which it will be stored.

A computer and a database coupled to the computer for storing sets of data for each file folder may be provided, which are linked by means of the file folder's unique identifier. The kinds of information stored in the database for each file folder may include, as a minimum, the identifier, the physical thickness of the file folder, and the storage section to which the file folder is assigned. In addition to this information, the file database may include various information related to the file folder's content. In the case of a medical file folder, for example, the content information advantageously may include the patient's visit history, disease history, and other information.

Whenever a file folder enters or leaves the file room or file storage facility, it may be logged-in or logged out through a logging station, which is coupled to the computer. The logging station may update the thickness measurement for the file folder. The thickness may be determined by measuring the file folder's weight, ideally on an electronic scale, although it is contemplated that the measurement could also be determined by physical measurement with an electronic caliper. The weight measurement may be converted by the computer to an updated thickness measurement by applying an algorithm that relates weight to thickness. The total file thickness for that file's assigned shelf section may be recalculated and compared to a user-chosen threshold value, usually in the range of 90 to 95 percent. Information related to the file folder's content such as, for example, patient appointment history, also may be updated in the computer database.

If the total thickness for all file folders within a storage section exceeds the set threshold percentage of the available storage space for the storage section, a purging subroutine may be initiated. A set of computer algorithms may apply file-usage criteria to each file within that file section to identify some folders for purging within that section. The folders for purging may be added to a purge list, which may be printed out to be used as a guide by personnel performing the actual physical purging, usually during the night. The purged files may be removed for shipment to off-site storage. The purging subroutine may be configured to identify only the file folders needed to reduce the total thickness for all file folders below the threshold percentage for that section.

For the current shelf section, the file folders may be purged according to the likelihood that certain files will not be requested in the future, for example, by applying purging algorithms to the individual files. The purging may proceed in two stages. In a first stage, file folders may be purged based on a set of predetermined criteria, such as previous visit history, zip code, disease code, type of exam, and other factors that would be predictive of whether that particular folder would not be requested again. In a second stage, file folders may be ranked according to the date of last visit.

In some embodiments, document image scanning provides multiple copies of pertinent file information to fulfill multiple pending file requests. Further, in some embodiments, the file folders include radio frequency identification tags for passive detection of file folder identification. In a still further embodiments, data from a shelf manager system controls a digital printing press to create direct print color-coded file folders for use with the shelf manager system.

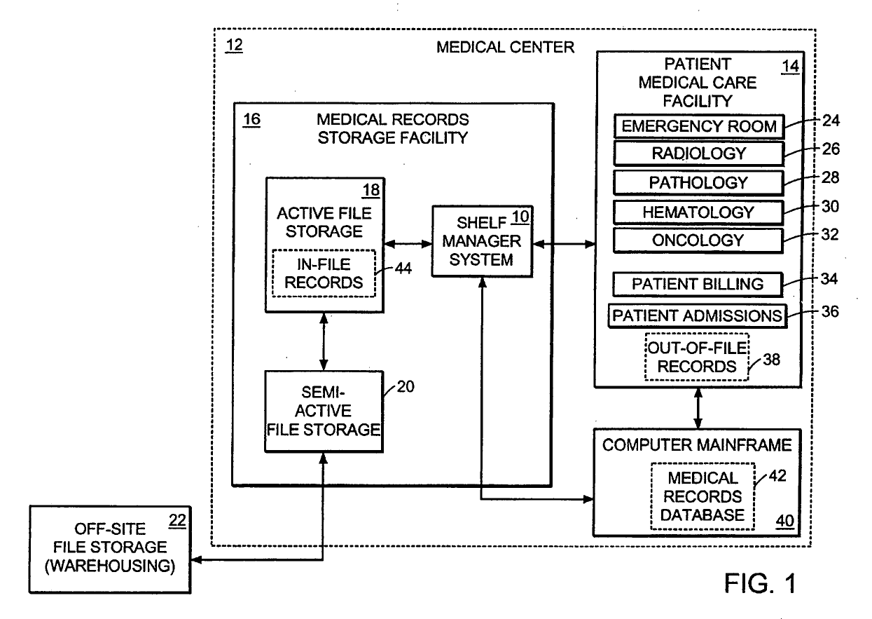

Turning initially to FIG. 1, a system is shown which incorporates a shelf manager system 10 in accordance with some embodiments of the invention. The system of FIG. 1 may be used in a medical center 12 or like environment. However, it should be noted that the principles of the present invention are applicable in any environment in which large volumes of records are kept as paper or digital files. Such other environments include, for example, federal and state government agencies, law firms, and insurance companies. Also, although some embodiments are discussed below primarily in relation to file folders stored on open shelving, for simplicity, it is understood that the principles of the present invention apply equally to other expandable file holders such as x-ray jackets, which typically include an outer jacket, an inner jacket and the x-ray film itself. Further, although some embodiments are discussed below primarily in relation to files stored on open shelving, it should be understood that the principles of the present invention also apply to file systems using filing cabinets or other file storage means.

In general terms, the shelf manager system 10 may comprise any of: a computer, computer software, and related computer input and output devices which are used to dynamically track and control the movement of file folders between a patient medical care facility 14 and a medical records storage facility 16. The term “file activity” is used herein to express a measure of the likelihood that a given file folder will be requested for transfer to the patient medical care facility 14, or, for digital files, the likelihood that a given digital file will be requested to be accessed by a user (e.g., using a computer). Active files are those having the highest file activity and are most likely to be requested; semi-active files have lower (e.g., much lower) file activity and are less likely to be requested than active files; and inactive files have the lowest activity (e.g., name) and are therefore the least likely to be requested.

The shelf manager system 10 may analyze file folder activity using a set of computer-implemented algorithms that identify: the most active files, which may be stored in active file storage 16; the next grouping of semi-active files, which may be stored in semi-active file storage 18; and inactive files, which have a very low likelihood of being requested and thus may be safely stored in off-site warehousing facilities 20 permanently or for infrequent retrieval.

System 10 may determine file folder activity, at least in part, accomplished by tracking paper growth in the active file storage 18, for example, by continuously calculating the total thickness of paper sheets added or subtracted from the file system as a whole, and particularly within file storage sections, as will be described, and producing a purge list whenever a predefined threshold is exceeded. The purge list may be used for removing certain low activity files from the active file storage 18 to reduce the total thickness below the threshold. Based on the principles of operation of the present invention, the file storage system may be more efficient than known systems increased because the files that are most likely to be requested are the same files that are most likely to be resident in active file storage 18, and files that are less likely to be requested are moved either to semi-active storage 20, or to off-site storage 22. The present invention also ensures that the available file space in the active file storage 18 is almost fully utilized. In addition, the shelf manager system 10 of the present invention prioritizes and handles pending requests and provides reporting functions.

In FIG. 1 the medical center 12 may be, for example, a large metropolitan hospital or even a small medical affiliate, which would typically provide medical treatment services to patients and also be capable of providing these medical services to the same patient population over an extended time period. The medical center 12 may include a patient medical care facility 14 and a medical records storage facility 16, which stores and manages all individual patient files, generally in the form of paper files contained in folders, which will be described in more detail below.

In a metropolitan hospital, the patient medical care facility 14 is typically departmentalized into a number of functional units having various diagnosis or treatment specialties such as, for example, emergency 24, radiology 26, pathology 28, hematology 30, and oncology 32. This listing is merely exemplary and not all-inclusive. In addition to diagnosis and treatment departments, the patient medical care facility 14 also may include administrative (non-diagnosis and non-treatment) departments such as patient billing 34 and patient admissions 36. Again, this listing is merely exemplary and not all-inclusive. For a given patient seeking treatment for illness or injury, multiple departments normally are responsible for the patient's processing, diagnosis, and treatment. Those departments typically require access to the patient's medical file for reasons related to the specialty of each requesting department, and the files typically need to be updated with new information from the diagnosis or treatment that was performed or for administrative reasons, or both. The various departments may request patient files to be physically transferred from the medical records storage facility 16 to the patient medical care facility 14, as needed, and then returned to the medical records storage facility 16.

Requests for patient file folders are called pending requests and it is possible for there to be multiple pending requests for a patient's file folder at any one time. The shelf manager 10 may track all pending requests. Pending requests may be entered into the shelf manager system 10 and routing slips may be printed. The requested patient file folder then may be physically removed from the shelf and routed to the requester. When the file is returned to the medical records storage facility 16, the shelf manager system 10 may search for any other pending requests. If other pending requests are found, the file folder may be electronically flagged and rerouted to the requestor's locale. This process may continue until all the pending requests are filled for a particular patient's file folder. When a pending request has been filled and the file moved from the file storage facility 14, the file may be termed an out-of-file record 38. Out-of-file records 38 may be physically within the requestor's department or in transit between departments.

In addition, the medical center 12 typically includes a computer mainframe 40 (or other type of computer, e.g., a server), which stores data related to individual patients in a medical records database 42. The kinds of information tracked for individual patients may include any of: name, address, visit history, disease & treatment codes, insurance, and billing information. The computer mainframe 40 may be physically located within the medical center 12 or at a separate or distant location. If at a separate location, the computer mainframe 40 may be accessible to designated hospital personnel in the medical center 12 by means of a communications network such as, for example, a conventional local area network (LAN), a metropolitan area network (MAN), an enterprise-wide network, a wide area networking (WAN), another type of network, or any combination of the foregoing. Although medical records computers, such as the computer mainframe 40, store an increasing quantity of patient data, the primary patient files typically are in paper form. The trend is toward increased storage of patient records in electronic form, but reliance on paper records should continue for the immediate future, perhaps well into the future.

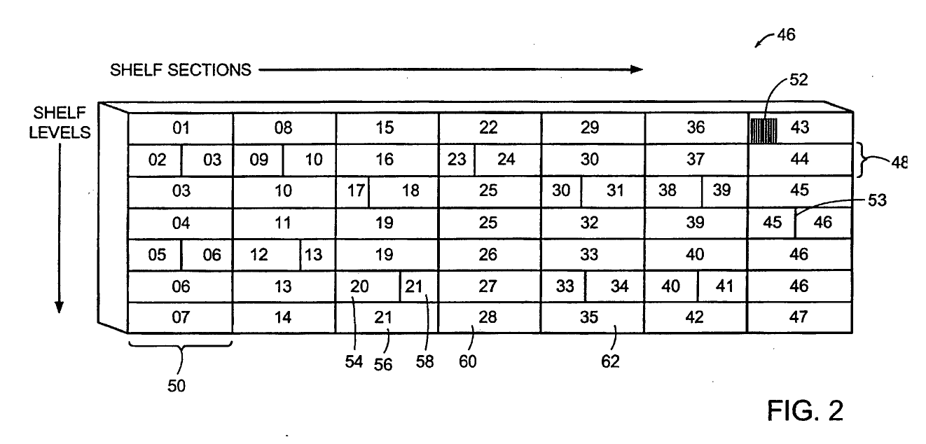

In FIG. 1, it can be seen that the medical records storage facility 16 may include an active file storage 18 for storing in-file records 44, and a semi-active file storage 20. The active file storage 18 may generally in the form of static shelving, which will be described in more detail in connection with FIG. 2. The active file storage 18 has to be sufficiently large to provide storage space for the majority of files which may be requested by the patient medical care facility 14. For a large metropolitan hospital, the number of files in active storage may number more than 400,000, partly because patient files are rarely destroyed and the patient files may go back several decades. It is important for the active storage 18 to be in close proximity to the patient medical care facility 14, so that patent records as required by the various medical departments are conveniently accessible to the doctors, laboratories, and administrative personnel in the patient medical care facility 14 as needed, without undue delay.

The difficulty of maintaining a large active storage 18 is readily apparent. As total file volume grows, the conventional solution has been to physically add additional space and personnel to cope with the increased volume. New medical records storage facilities typically are acquired in the form of additional buildings and support staffs to handle the need for increased storage space. The shelf manager 10 may eliminate the need for providing additional active file storage by efficiently utilizing the existing space, specifically by keeping the active file storage 18 as full as possible only with those files that are most likely to be requested by the patient medical care facility 14. The remaining files may safely be moved to the semi-active storage 20, where the files are stored on less-accessible mobile shelving units, which provide an increased storage density, and finally to low cost off-site storage.

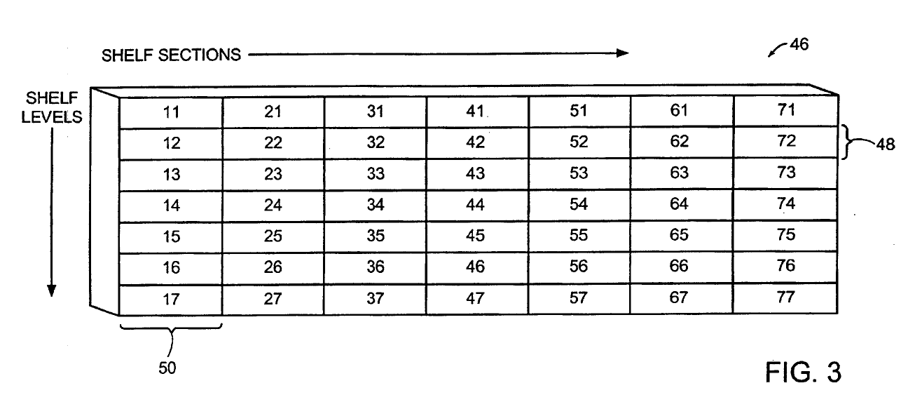

Referring now to FIG. 2 and FIG. 3, the organization of the active file storage 18, according to some embodiments of the invention, is shown in more detail. For the purposes of the present discussion, the active file storage 18 is advantageously localized to a single file room. However, the principles of the present invention are application to file storage configurations of all types without limitation. The file room may include several steel shelf units 46, organized and arranged in an optimal manner to form aisles, to maximize the use of available space. Each shelf unit 46 may include a plurality of shelf levels 48 and shelf sections 50. Shelves of this type are typically eight feet high and accommodate six to ten shelf levels. Also, each shelf section has a typical length dimension in the range of 30 inches to 48 inches. The shelf manager system 10 may track the fullness of each shelf independently, so there is no need to have all the shelf units be uniform in height or length.

The file folders 52 may stand freely on the shelf and preferably fill a shelf section most efficiently from left to right, rather than being stacked from bottom to top, although the present invention is not limited to the method used to fill the shelves.

The shelf arrangement may include vertical file supports or vertical file guides 53 utilized to provide support to the file folders in sections which are less than full or to otherwise subdivide a shelf section, as will be described in what follows.

In some embodiments of the invention, the file room is subdivided into a number of subsections, and the subsections are advantageously designated by unique numbers or other indicia. Also, it is not required for the subsections to be the same width as shelf sections. In FIG. 2, the shelf subsection 54 which shows the identifying number “20” is smaller than one shelf section width, while the shelf subsection 56, 58 which shows the identifying number “21” is larger than a section width. As a third example, the subsection 60, which shows the identifying number “28” is exactly equal to a subsection width. FIG. 2 also illustrates that shelf subsections need not be constant in width. Over time, some subsections will expand and some sections will contract, because the thickness of individual file folders will vary.

In contrast, FIG. 3 shows an alternative shelf arrangement in which the subsections are equal in width to the shelf sections. In both shelf arrangements shown in FIG. 2 and FIG. 3, each subsection may have a unique identifier, allowing the subsection to be tracked independently of the other shelf subsections. Also, each shelf subsection may advantageously be bar coded so that its location may be tracked by the shelf manager system 10. In some embodiments, the file folders 52 are organized according to the terminal digit filing system, which is widely used in many industries, particularly the medical field.

In the case of a typical medical center 12 such as a hospital, patient file numbers may be issued sequentially, and typically are never reused. It would not be uncommon for a large hospital to have issued more than a million sequential patient numbers over the years. In such a case, a newly issued file number might typically be “123-45-67,” which may represent the 1,234,567^{th} patient to enter that hospital.

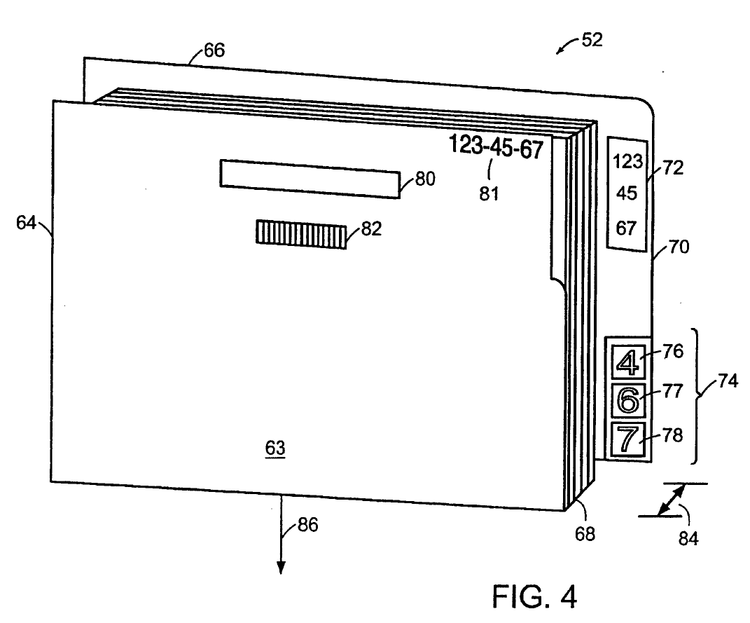

Terminal digit filing seeks to distribute the file folders 52 evenly in the total space available in the active file storage 18. Under this system, the active file storage 18 may be divided, initially, into 10,000 even sections. The first division of the file space may consist of 100 main sections representing the last two digits, 00 to 99, of a sequentially-issued number series of indeterminate length. These last two numbers are called the terminal digits (TD). For example, in the number 123-45-67, the terminal digits are “67.” The “6” is the first terminal digit, representing ten percent of the total available file space; it is usually signified by the middle position color band on a side tab folder with three positions of color bands, manufactured for open shelf filing. The color coding of file folder 52 will be described in more detail in what follows and further on with reference to FIG. 4. The “7” is the second terminal digit, representing one percent of the total available file space; it is usually signified by the bottom position color band on a side tab folder with three positions of color bands, manufactured for open shelf filing.

The 100 terminal digit sections, 00 to 99, are each divided into 100 subsections, each subsection designated by two digits, 00 to 99, called the middle digits (MD). In the example 123-45-67, the middle digits are “45.” The “4” is the first middle digit, representing 0.1 percent of the available file space; it is usually signified by the top position color band on a side tab folder with three positions of color bands manufactured for open shelf filing. The “5” is the second middle digit, representing 0.01 percent of the available file space. Unless the active file storage 18 is unusually large, designed to accommodate several hundred thousand to a million or more file folders 52, it will not usually be necessary to add a fourth color band to represent second middle digit.

The first three digits, “123” in the example number 123-45-67, are called the tertiary digits and are filed in sequential order after the file folder 52 is placed in terminal digit and middle digit order. If all the numbers in a series of 1,234,567 numbers were in the same file space, the tertiary digits in this example would designate the 123^{rd} folder filed in sequential order in the “45” middle-digit subsection of the “67” terminal-digit section.

Terminal digit filing uses color-coding to identify files belonging to the same section or subsection. Using terminal digit filing, it is almost impossible to misfile a file folder, because of the color bands associated with each file. If a file folder 52 is misfiled, it will attract attention because of its different color-band pattern compared with the other file folders 52 for that subsection. Using color coding to represent both of the terminal digits and the first of the middle digits of a sequentially issued number reduces the area of a possible misfile to 0.1 percent of the total active file storage 18. An active file storage 18 containing 150,000 folders would have 150 file folders 52 in each middle digit section with the same color bands. In the present example, terminal digit 7 is represented by the color brown in the bottom band; terminal digit 6 is represented by the color yellow in the middle band; and middle digit 4 is represented by the color purple on the top band. Typically, these 150 file folders 52 would fit on a single shelf, and any misfiles would be limited to this area or would show up as a clash of color in another section. Using the terminal digit filing system, file numbers in each subsection should grow evenly, statistically. This is true to a point; however, the thickness of individual files varies according the content of the file, which can be greater or less than average, depending on the quantity of patient data.

Turning now to FIG. 4, a typical file folder 52 is illustrated of the type which may be effectively utilized with the present invention. The file folder 52 may be of the type produced and manufactured by Ames Color-File of Somerville, Mass., for medical applications. The file folder 52 includes file stock substrate 63 folded into a front cover 64 and a rear cover 66. File content 68 is positioned between the front cover 64 and the rear cover 66, and consists of individual perforated paper sheets or pages of patient-related data. These pages generally include laboratory test reports, physician's notes and numerous types of pre-printed forms associated with the patient's processing, diagnosis, and treatment. The file content 68 is continually supplemented and updated and thus provides a historical record of the treatment of the patient. In cases where a patient is undergoing extensive or continual diagnosis and treatment, or in cases when the patient has been using the same hospital for many years, more than one volume or even several volumes may be required for a single patient.

The file content 68 is generally held between the file folder covers 64, 66 by a flexible paper fastener such as, for example, a flexible paper fastener as described in U.S. Pat. No. 4,084,911, which is hereby incorporated by reference.

The rear cover 66 includes a tab portion 70 for indexing the files. The tab 70 of the rear cover 66 extends beyond the edge of the front cover, so that, when the file folder 52 is in-file in the shelf unit 46 shown in FIG. 2, the tab 70 will be visible at a glance or from a distance. The tab 70 includes a patient number block 72 and the terminal digit number 74, which indicates the section wherein the file folder 52 is to be filed. The individual digits of the terminal digit filing system 74 are included on small color-coded squares 76, 77, 78, wherein specific digits correspond to specific colors, as previously described. In FIG. 4, the digits “467” represent the terminal digits “67” and the first middle digit “4.” A file folder 52 with this designation will be properly filed in section “67” of the 100 sections of the file room and in subsection “4” within that section. The color-coding is visible from a distance, so that it is immediately apparent that the file folder 52 has been correctly filed with respect to the other file folders 52 having the same terminal digits, as discussed above. As part of the present invention, during manufacture of the file folder 52, the patient name, terminal digit numbers and color-coded squares may be provided by means of direct printing on the substrate 63 of the file folder from a digital color press, for example, of the type manufactured by Indigo Nev. of Maastricht, The Netherlands, which utilizes liquid toner for high speed color printing. This embodiment of the present invention will be described in more detail further on.

The front cover 64 includes a patient name block 80 as well as a second patient number block 81 to provide additional file identification indicia when the file folder is removed from its shelf. The front cover 64 also includes a bar code label 82, which is utilized by the shelf manager system 10 of the present invention for tracking data about the file, as will be described in what follows.

The file has an associated thickness measurement 84, which indicates how much file space a file takes up on a shelf, and this measurement may be used by the shelf manager system 10 to create a file purge list. The file content 68 consists essentially of single sheets of paper, which have an average thickness of approximately 0.01 inches. The thickness 84 of the file folder 52 has been found to average approximately 200 pages per inch, including the thicker front cover 64 and rear cover 66 with the tab 70. It is within the scope of the present invention to provide measurements of the thickness 84 of file folders directly by means of an electronic caliper or the like.

It has been recognized that a file folder's weight 86, indicated by the arrow in FIG. 4, is proportional to its thickness 84. Therefore, in some embodiments, by weighing a file, and by making a simple mathematical computation, a thickness determination can be made. Specifically, one sheet of paper weighs approximately 0.01 pounds, and an empty file folder weighs approximately 0.1 pounds. A file folder having a thickness 84 of one inch also has a folder weight 86 of approximately 2.0 pounds. Although it is recognized that paper sheets and folder stock are available in a range of thicknesses, the averages presented here have been found to work effectively in achieving the objectives of the present invention.

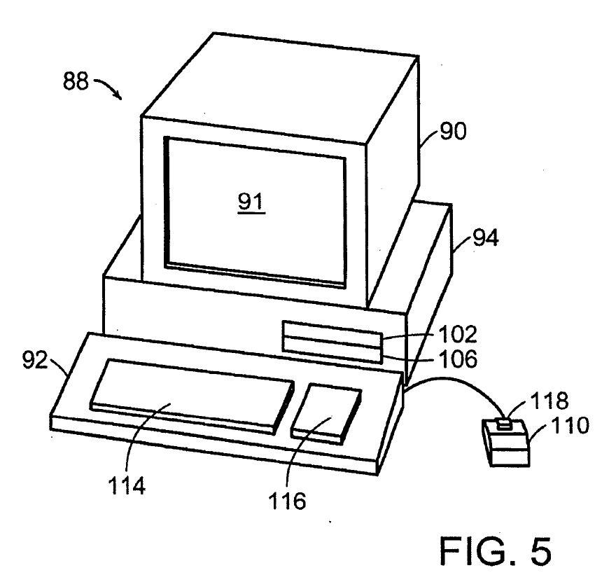

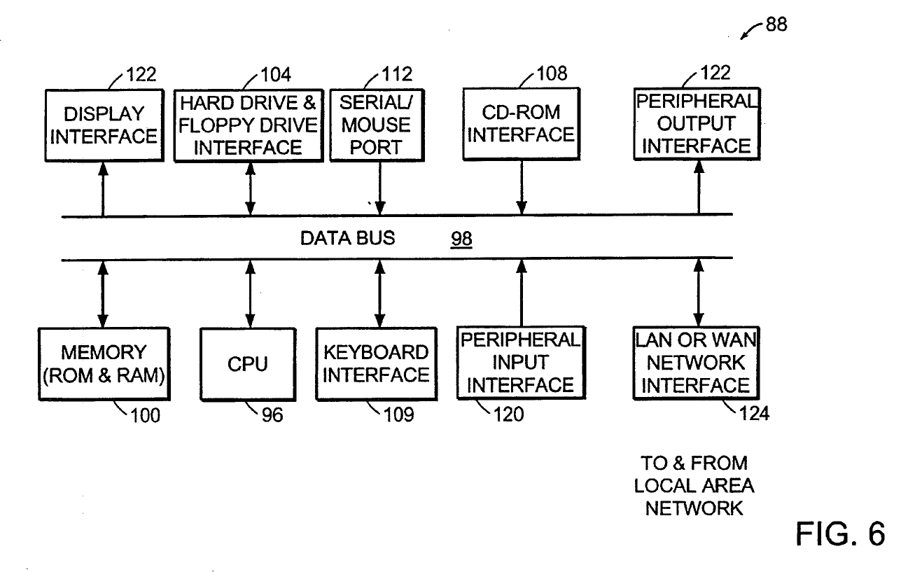

Referring now to the FIG. 5 and FIG. 6, a computer system 88 is illustrated which is incorporated in the present invention. The computer system shown in FIG. 5 and FIG. 6 is a standalone desktop computer system, such as, for example, a Dell Optiplex Pentium-II personal computer manufactured by Dell Computer Corporation of Round Rock, Tex. However, it is to be understood that other general purpose computer systems may be advantageously used in the present invention.

The major physical components of the computer system 88 may include a display monitor 90 including a display screen 91, a keyboard 92, and a computer base unit 94 that internally houses a number of electronic circuits including central processing unit (CPU) 96. As shown in FIG. 6, the computer system 88 comprises a bidirectional data bus 98 interconnecting the CPU 96, a plurality of input devices, output devices, and the system memory.

The base unit may include internal memory 100, on a circuit card therein, typically comprising random access memory (RAM) for temporary storage of information and read-only memory ROM for permanent storage. Also housed in the base unit 94, may be a computer system 88 that may include one or more mass storage devices in the form of hard disk drives and floppy disk drives 102, which are connected either directly or indirectly to the computer's data bus through a hard drive & floppy drive interface 104. Additional mass storage may be in the form of a conventional CD-ROM which may be connected to the computer's data base through a CD-ROM interface 108. For descriptive purposes, the computers internal memory 100 and mass storage devices 102, 106 will be collectively referred to as “storage” when data can be stored in any type of data storage unit.

Computer input is provided, for example, by a conventional keyboard 92 connected to the data bus 98 through a keyboard interface 109, and also may be provided by a conventional mouse 110 connected to the data bus 98 through a serial/mouse port 112. The keyboard includes a plurality of alphanumeric keys 114 and may also include a dedicated numeric keypad 116. The mouse 110 includes at least one button-type switch 118 operated by a user of the system. A cursor is displayed on the screen 91 and its position is controllable via the mouse 110 or the keyboard 92, as is well known. Herein, the terms “click” and “clicked upon” are used to describe the situation in which a cursor is positioned over a screen object and the mouse button 118 or one of the keyboard keys 114 is pressed and, in some implementations, then released. The computer 88 also may include a peripheral input interface 120 for connecting additional input devices as will be described below.

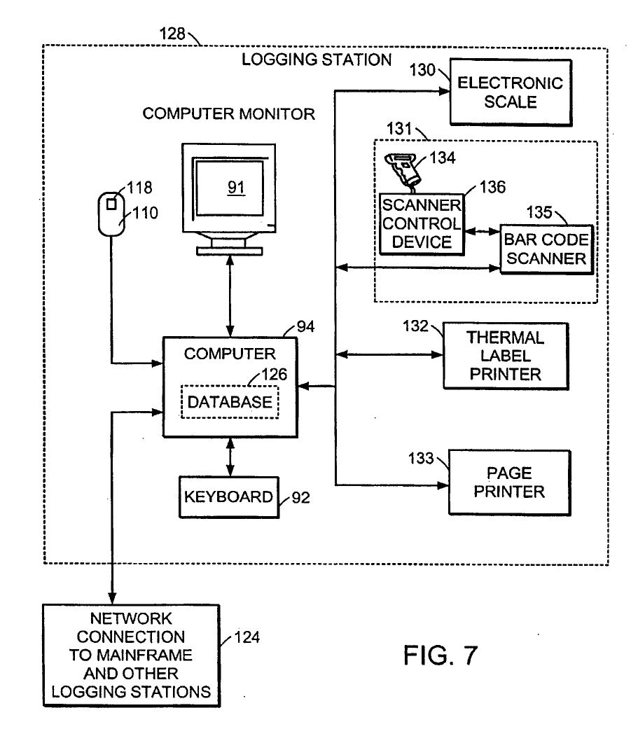

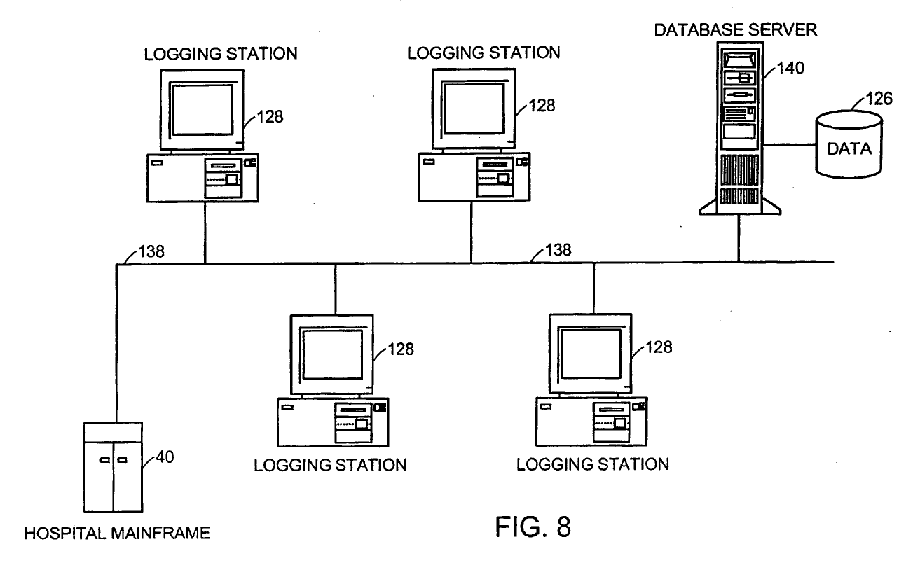

Computer output may be in the form of a conventional display monitor 90, having a CRT display screen, which may be connected to the system bus 98 through a display interface 122. The display device need not be a separate display monitor, but may be housed in the same unit as the CPU processor 96. The computer 88 also may include a peripheral output interface 122 for connecting additional output devices such as printers as will be described in connection with FIG. 7. The computer also includes a network interface 124 so that it may be linked to a local area network (LAN) or wide area network (WAN) as will be described in connection with FIG. 8.

In general operation of the computer 88, information in the form of control and data signals are received from the connected input devices. The signals may be provided via the system bus 98 to the CPU 96 for processing, for storage on the mass storage unit 102, and for display on the display screen 91, or for output of other peripheral output device.

The computer system 88 further may include operating software stored in memory 100 or stored in mass storage 102 and then loaded into memory 100 when executed. The software typically includes an operating system for controlling and coordinating the computer system 88. The present invention, operating in conjunction with the computer 88, includes the capability to process data, graphics, and sound while providing a windowing environment for display on the display monitor screen 91. The operating system may be a Windows 95, Windows 98, or Windows NT 4.0 or later operating system developed and sold by Microsoft Corporation of Redmond, Wash., or may be another operating system available from another company.

The shelf manager system 10 is a file management tool particularized for managing medical file folders, and may incorporate a relational database 126 to perform this function. This relational database may be developed utilizing any of a variety of data development systems such as, for example, Foxpro, created by Microsoft Corporation. Foxpro is an object-oriented data development system which provides tools for developing relational databases management systems and applications, which have the capability of organizing information into tables, editing that information, running queries, and running reports. The Foxpro product operates within the Microsoft® Windows® and DOS operating system environments and utilizes such features as pop-up dialogue boxes, which gives the user a choice of entering or modifying program parameters at key points while operating the database application. It is contemplated that other relational databases may also effectively be used to implement the principles of the present invention. Further, Visual Basic® (also available from Microsoft) or another programming language and/or tool may be utilized for interfacing to an electronic scale and bar-code scanner, which is described in what follows.

Turning now to FIG. 7, an example of a logging station according to some embodiments of the invention is shown. Whenever a file folder 52 is removed from or redeposited into active file storage 18, the logging station 128 may be used to identify the file folder 52 and to determine and update the file folder thickness 84 data by determining file folder weight 86. The logging station 128 may include any of: personal computer 88, an electronic scale 130 input device, a bar code scanner 132 input device, a thermal label printer 134, and a page printer 135. The various components of the logging station 128 advantageously may be located contiguously on a table-top location to provide for the cooperative operation of the various peripheral components.

The electronic scale 130, bar code reader 131, thermal label printer 132, and page printer 133 may be coupled to the computer 88 through the respective peripheral input interface 120 and the peripheral output interface 122.

The electronic scale 130 may be of the type available from Salter Weigh-Tronix Co. of London, England, which is a bench type scale having the capability of determining file folder weight 86 to a precision of 0.01 pounds. This weight corresponds to the weight of a single page of paper. Thus, the addition or subtraction of single pages of a file folder 52 may be accurately tracked using the scale. The computer 88 may use the weight 86 measurement to compute the current thickness 84 of the file folder 52.

The bar code reader 131 may include a standard gun type scanner 134 manufactured by PSC, Inc. and attached to a wedge decoder 135 manufactured by Percon, Inc. of Mount Wilson, Oreg. The bar code reader 131 may be used to scan the bar code label 82 on a file folder 52 so that it may be accurately tracked by the shelf manager system 10. It is anticipated that portable bar code scanners also may be used. Furthermore, the bar code reader 132 may incorporate a scanner control device 136 and supporting software. When the scanner is NOT READY or if a SCANNING ERROR occurs, the scanner control device 136 may be configured to shut off the scanner and the application software may provide an alarm to signal for appropriate intervention by the user.

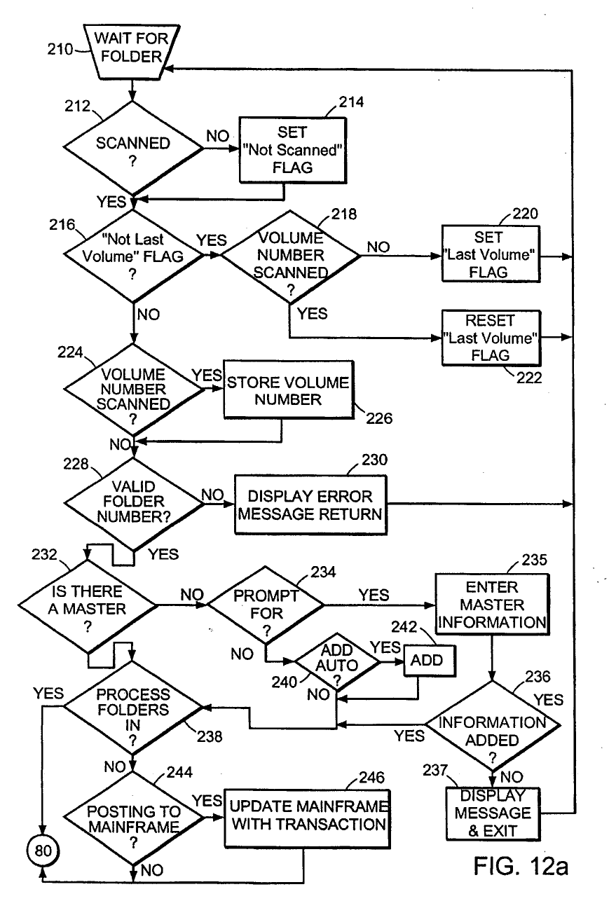

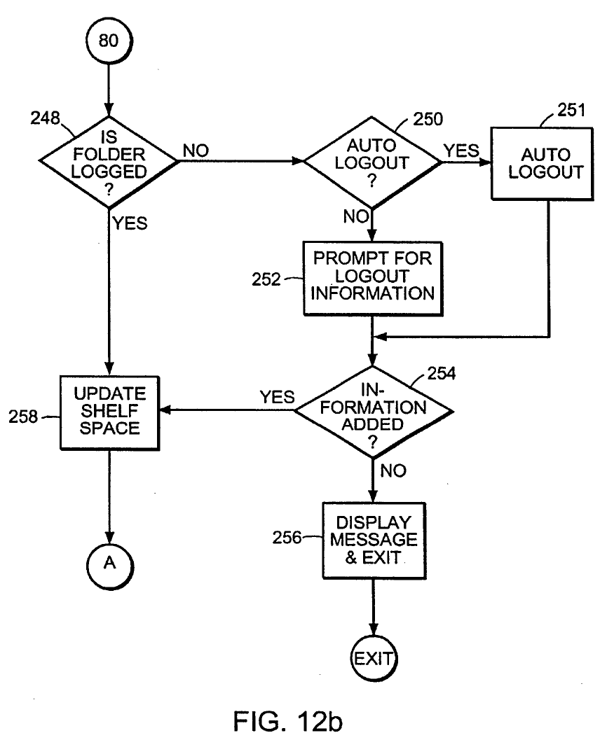

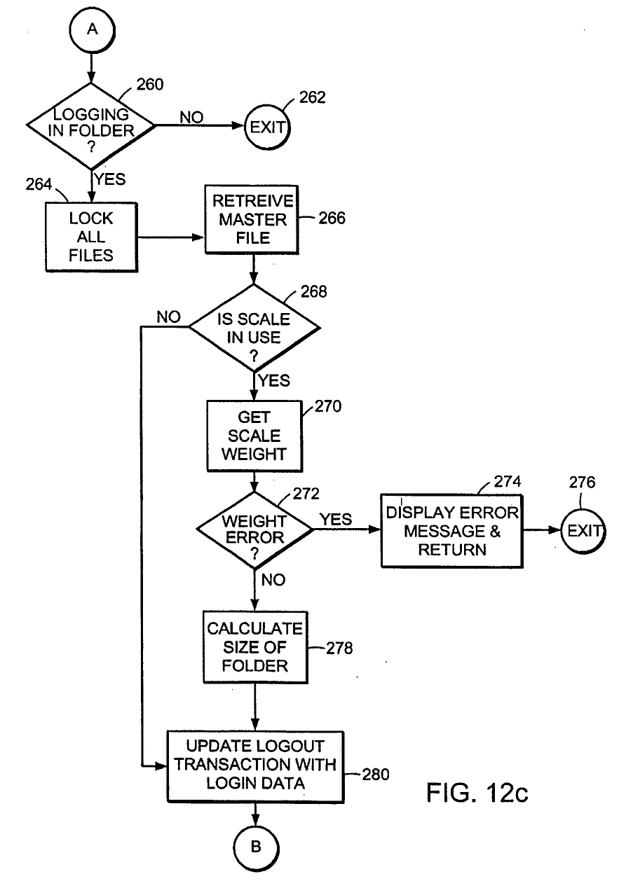

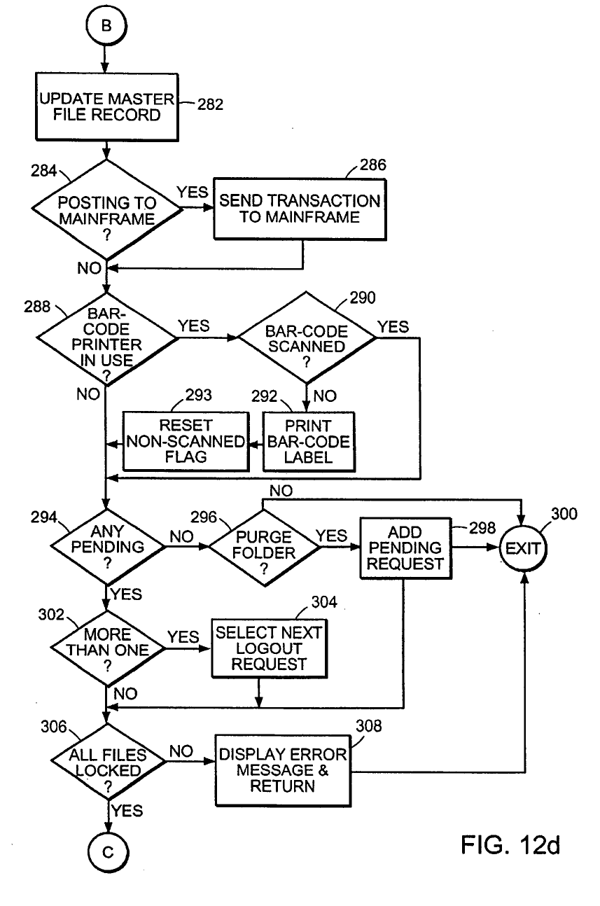

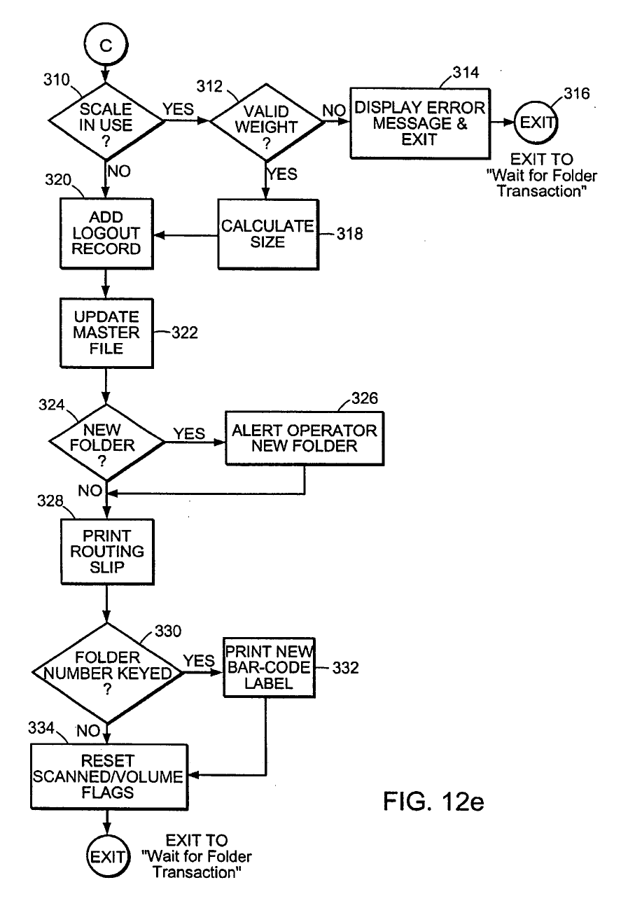

The bar code label printer 132 may be a direct thermal printer manufactured by Eltron, Inc. The shelf manager system 10 may be configured to automatically print bar code labels as required or whenever the operator manually types a record number. It is possible for one patient's folder to occupy one, two or several volumes. The shelf manager system 10 of the present invention may automatically determine when a second or additional volume should be created. A volume creation subroutine may automatically determine if the file folder thickness 84 exceeds a predetermined threshold value. In response to this indication, the shelf manager system 10 may initiate a file creation subroutine that automatically prints a file label for the new file folder volume. An example of this subroutine will be discussed in connection with FIG. 12.

The logging station 128 may be a standalone system, but it may also be part of a local area network, or a client-server network. Referring to FIG. 8, an example of an implementation of the present invention as part of an Ethernet network 138 is illustrated. In the figure, a number of logging stations 128 are shown, indicated as computer workstations, with the attached peripherals not shown for simplicity. It is conceivable that ten or more logging stations may be required to manage file folders in a major medical records storage facility 16. Also connected to the Ethernet network 138 may be the hospital mainframe 40, which may allow the individual logging stations to retrieve basic patient data from the hospital mainframe 40 and to update data to the hospital mainframe 40. The network configuration also may include a database server 140 which controls and provides network access to the database 126.

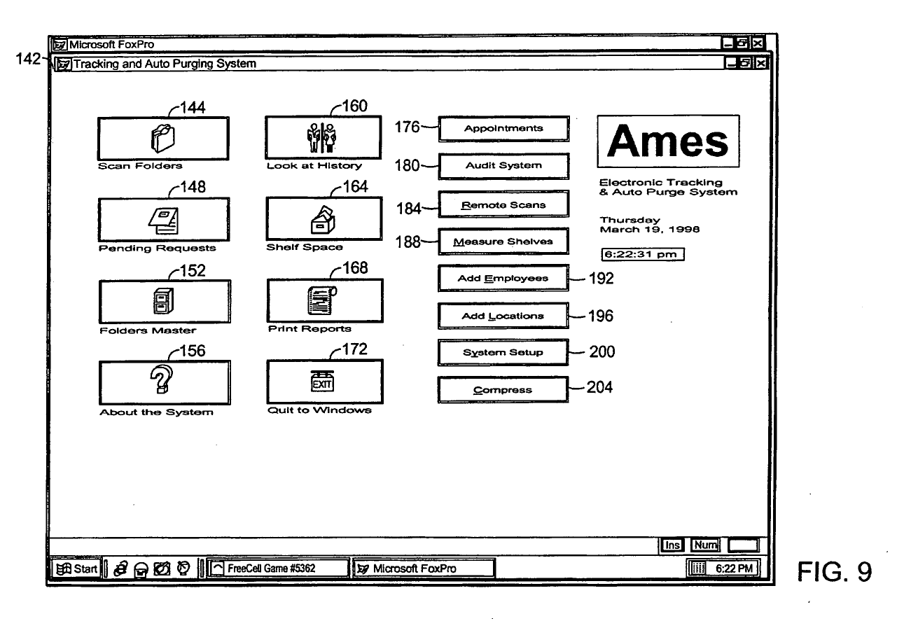

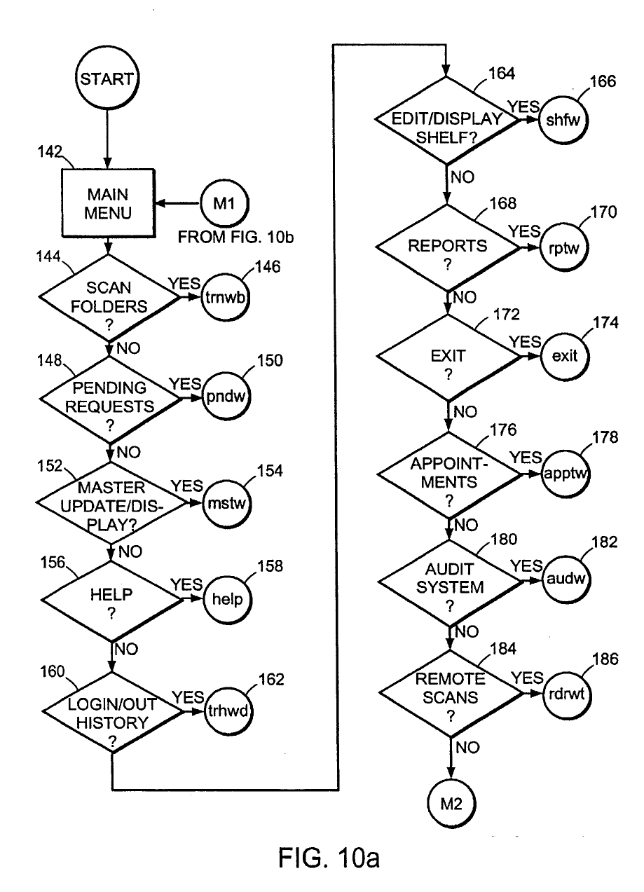

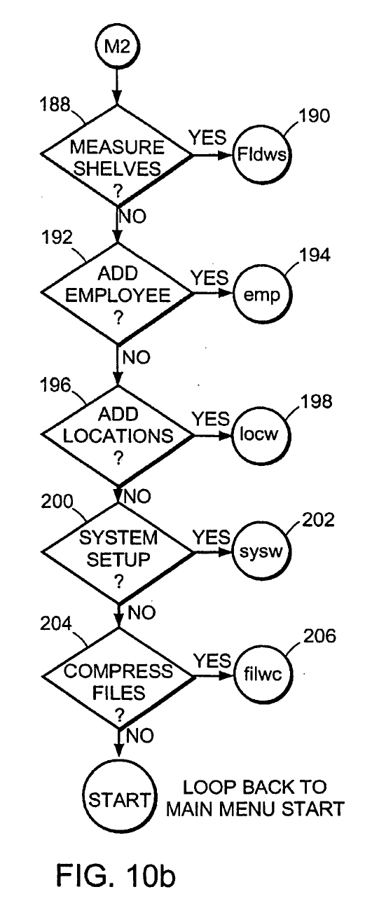

Turning to FIG. 9, an example of a user interface screen for the system menu 142 is shown as seen on the display device 91. The system menu 142 may include three columns of user-selectable screen buttons which call up various program functions. The screen buttons may be selectable in a conventional manner by moving a mouse-controlled cursor around the display screen 91 until the cursor is positioned over the screen location corresponding to the chosen function and then by clicking the mouse 110 to select that program function. When a program function is selected in this manner, the system may call up that subroutine to which the system call is directed, and the subroutine may be executed, which may provide the user with other screens which provide requested information or allow for the input of data or parameters necessary for that subroutine function. After completed execution of the user-selected functions, the main menu program may be configured to loop back to the system menu screen 142. The flowcharts in FIG. 10a and FIG. 10b show examples of the program functions associated with the main menu 142 for each of the various screen buttons shown in FIG. 9. The individual subroutines will be discussed in more detail in what follows.

The scan folders button 144 may call the subroutine TRMWB 146, which allows the user to log out folders to various locations including off-site storage locations, and allows the user to log folders back into the system. An example of a folder master function is described with more particularity in connection with FIGS. 12a-12e.

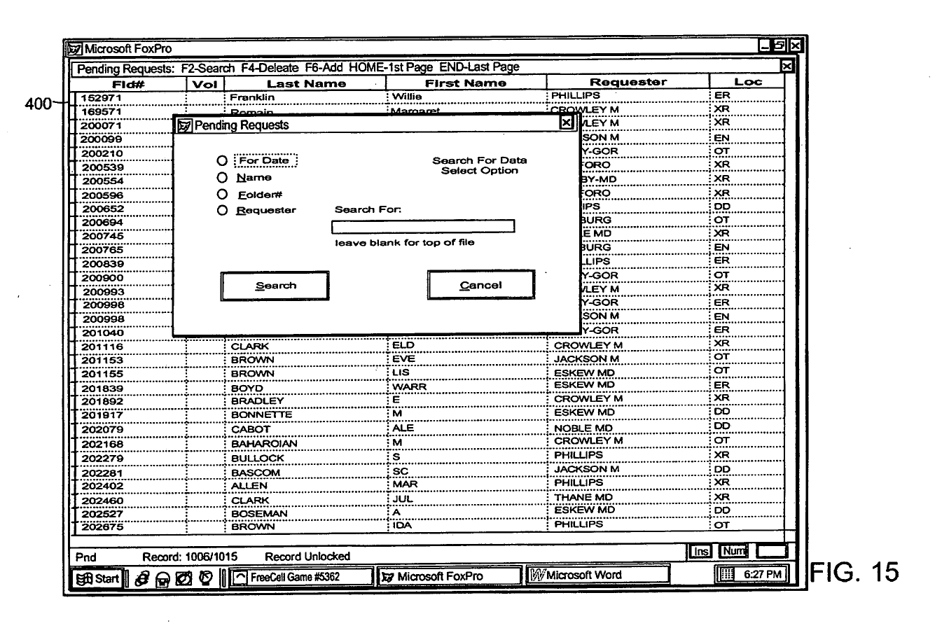

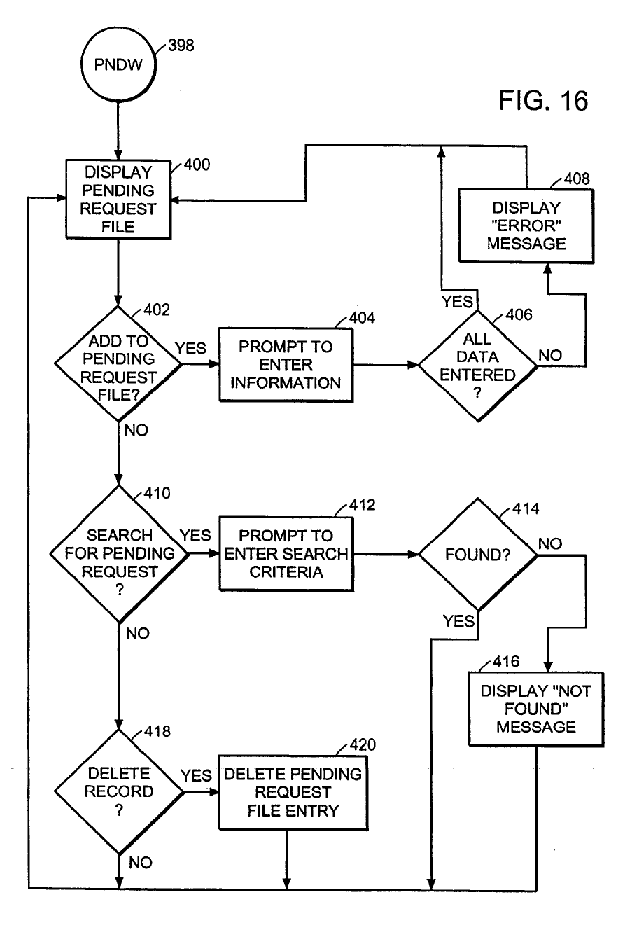

The pending requests button 148 may call the subroutine PNDW 150, which provides the user with screens to enter requests for folders and track those requests. An example of a pending request function is described with more particularity in connection with FIGS. 15 and 16.

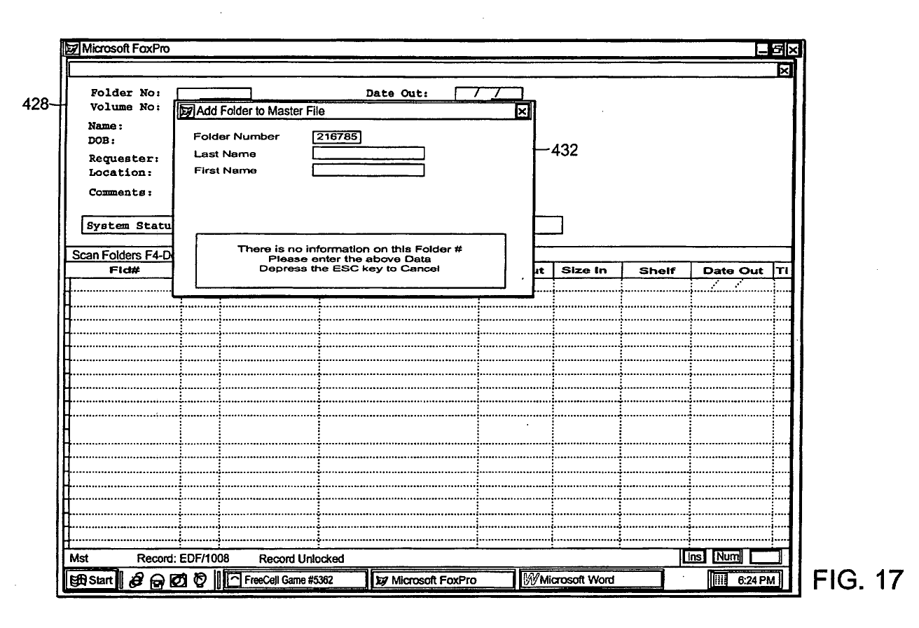

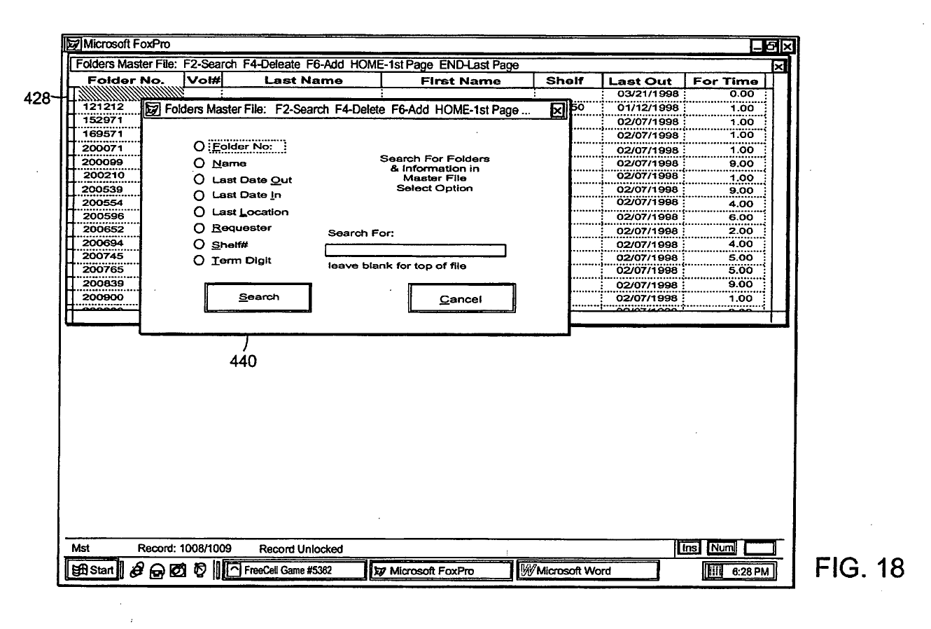

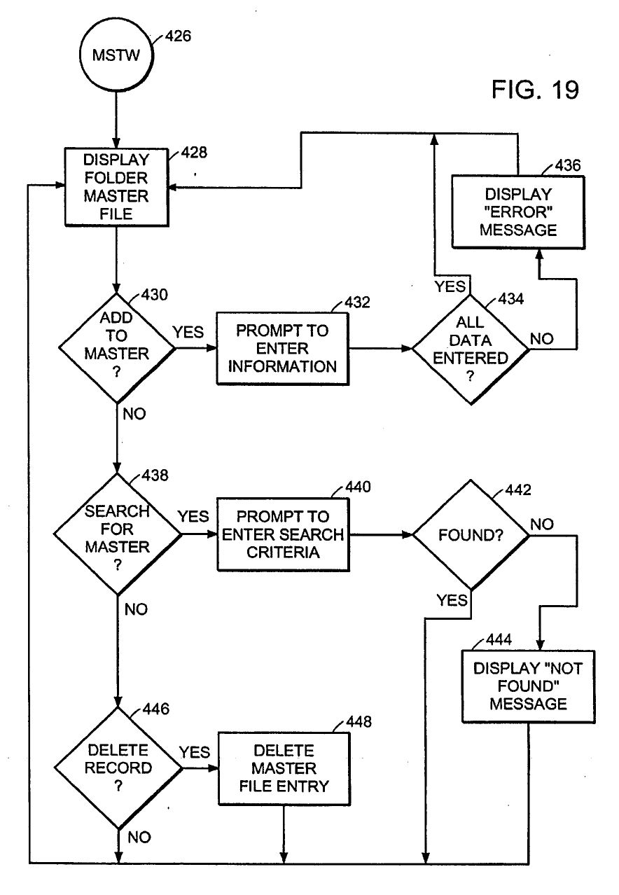

The folder master button 152 may call the subroutine MSTW 154, which provides basic information about a folder such as the last time logged out, the date of last log-out, the requester, and the location, etc. An example of a folders master function is described with more particularity in connection with FIGS. 17 through 19.

The about the system button 156 may call the HELP subroutine 158, which provides information about how to use the system to the user.

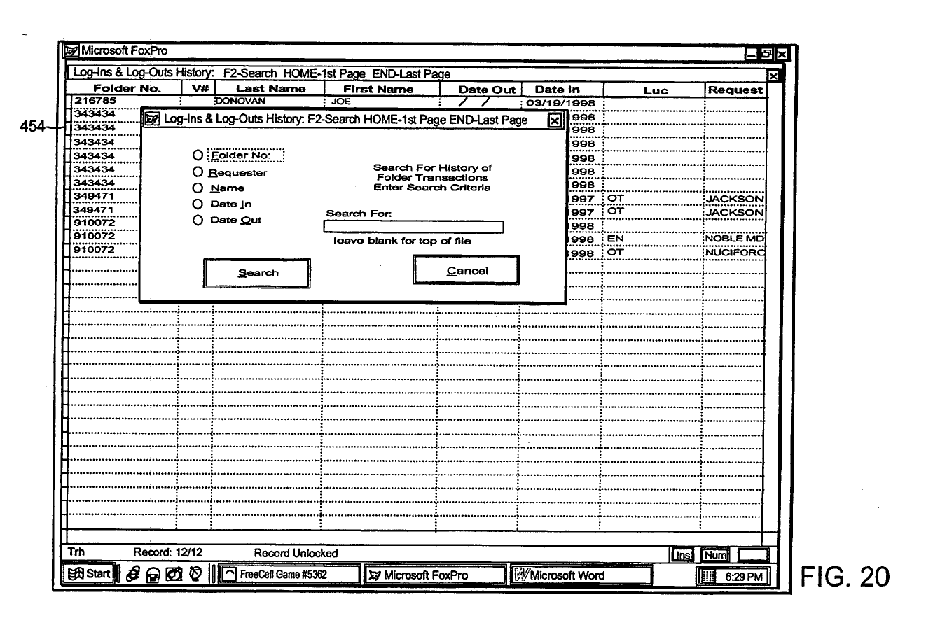

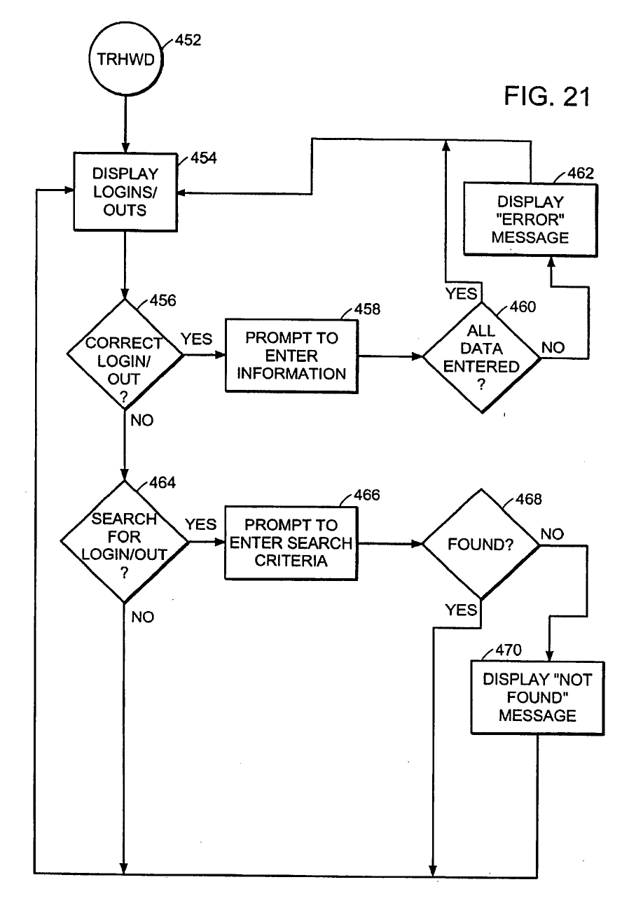

The Log-in/Log-Out History button 160 may call the subroutine TRHWD 162, which provides the user with a history of all folder activity. An example of a Log-in/Log-out History function is described with more particularity in connection with FIGS. 20-21.

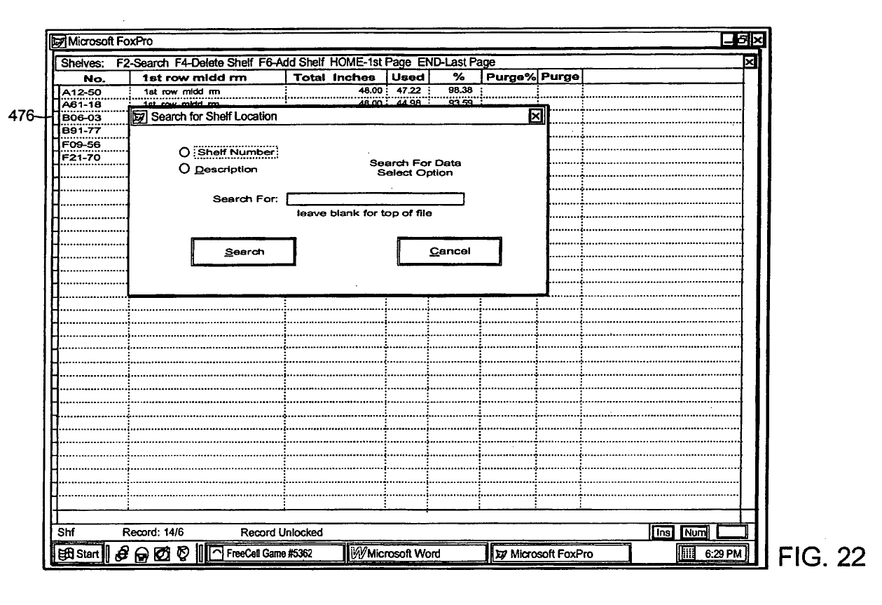

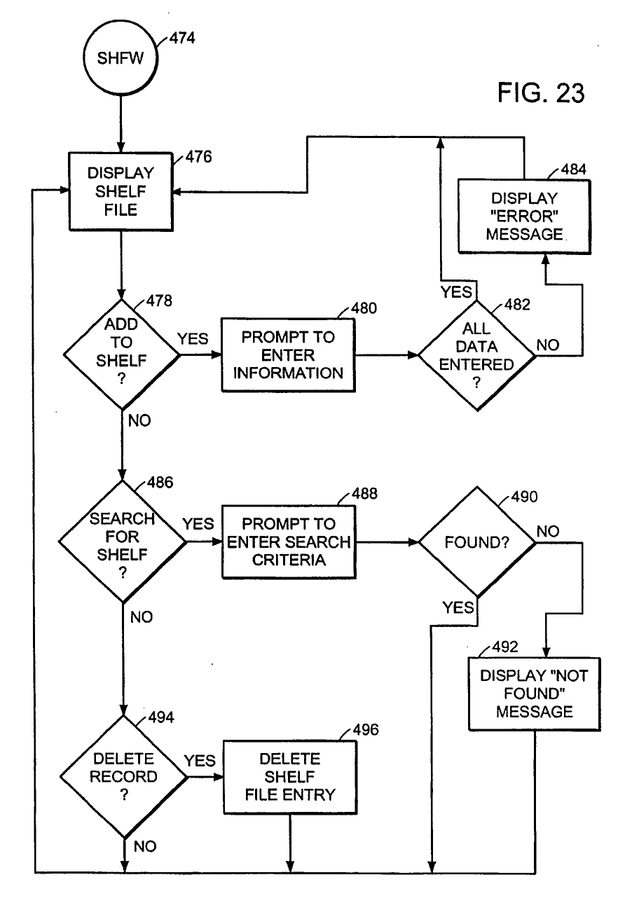

The shelf space subroutine 164 may call the subroutine SHFW 166, which may display statistics of all shelf space, including shelf size, inches used, and locations. It allows the user to edit existing data and enter new information about shelf spaces and locations. An example of a shelf space function is described with more particularity in connection with FIGS. 22-23.

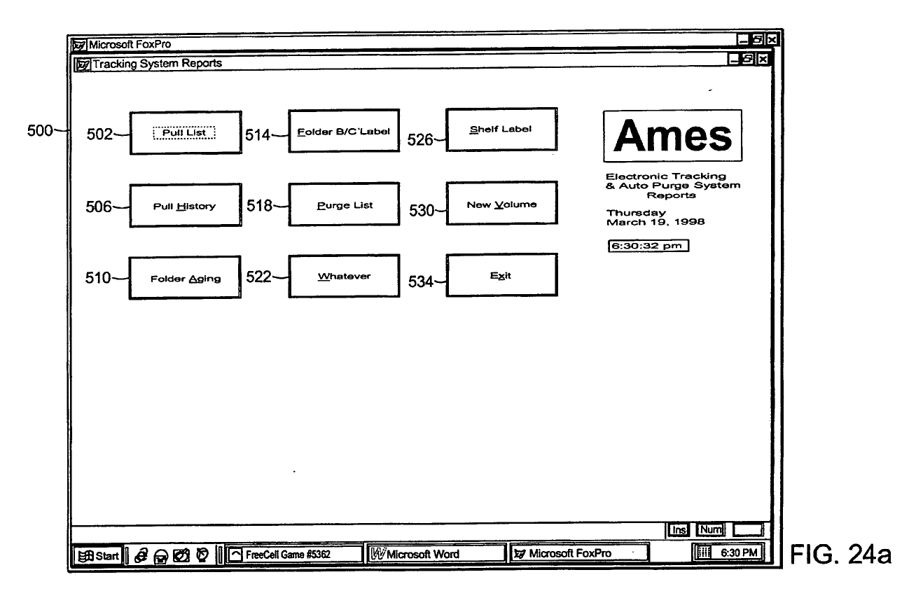

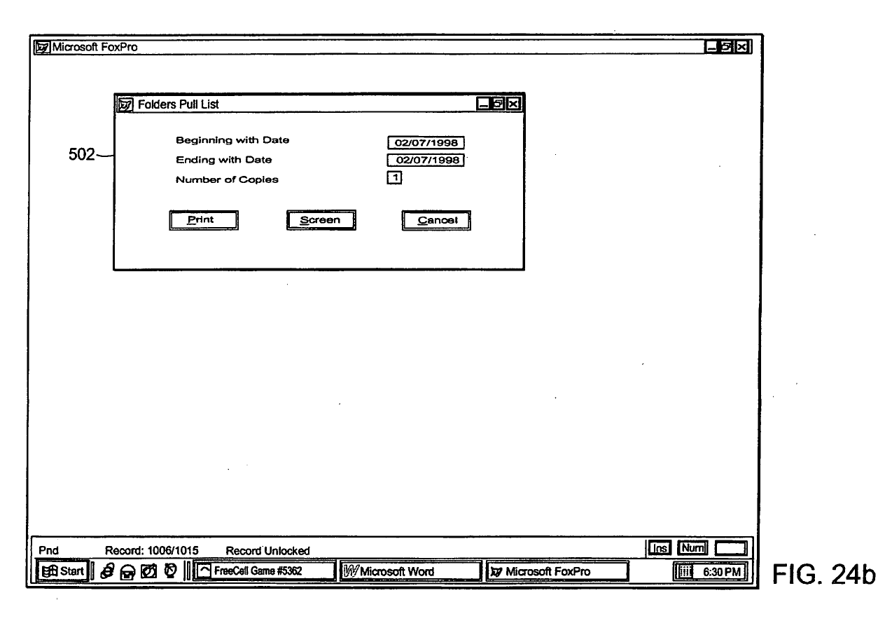

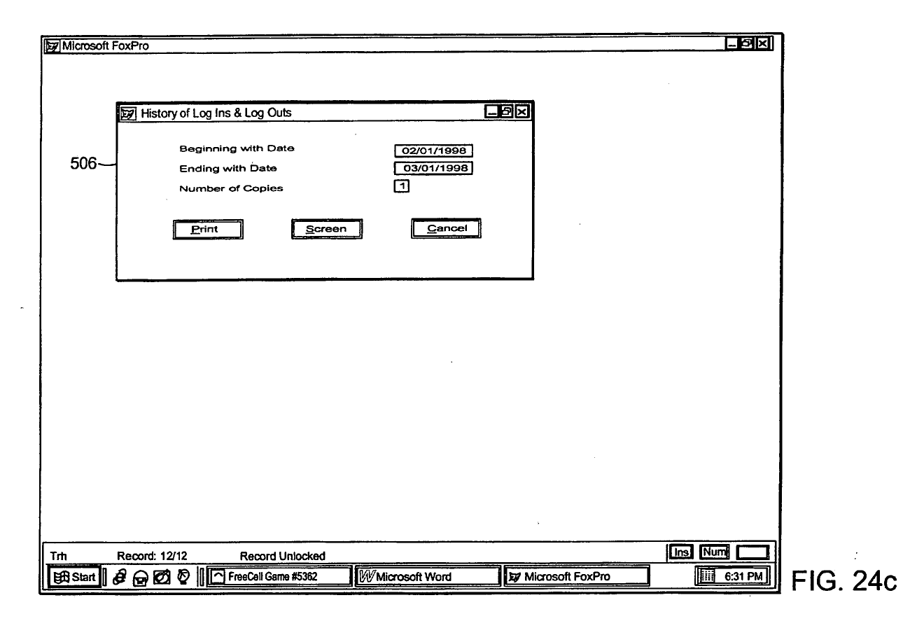

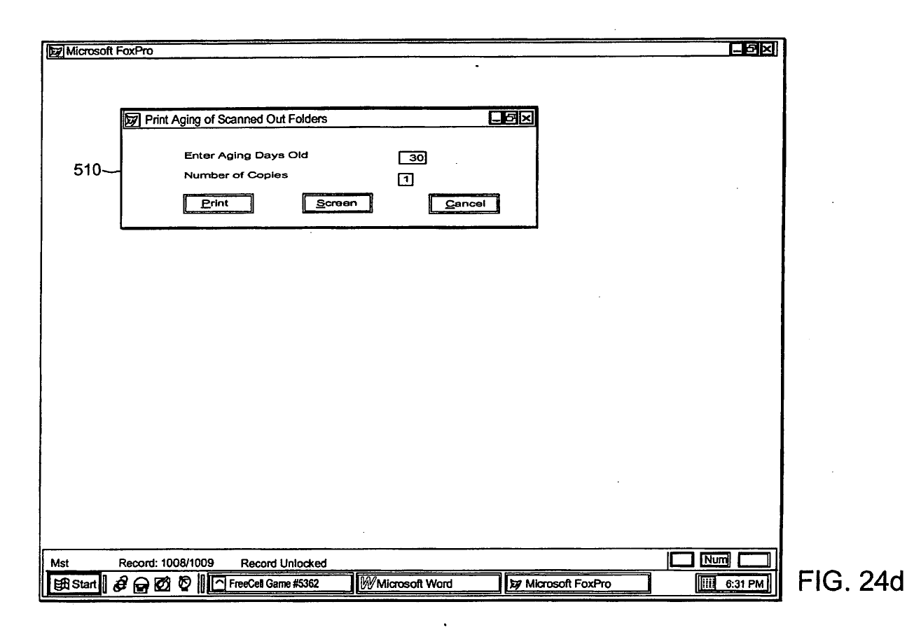

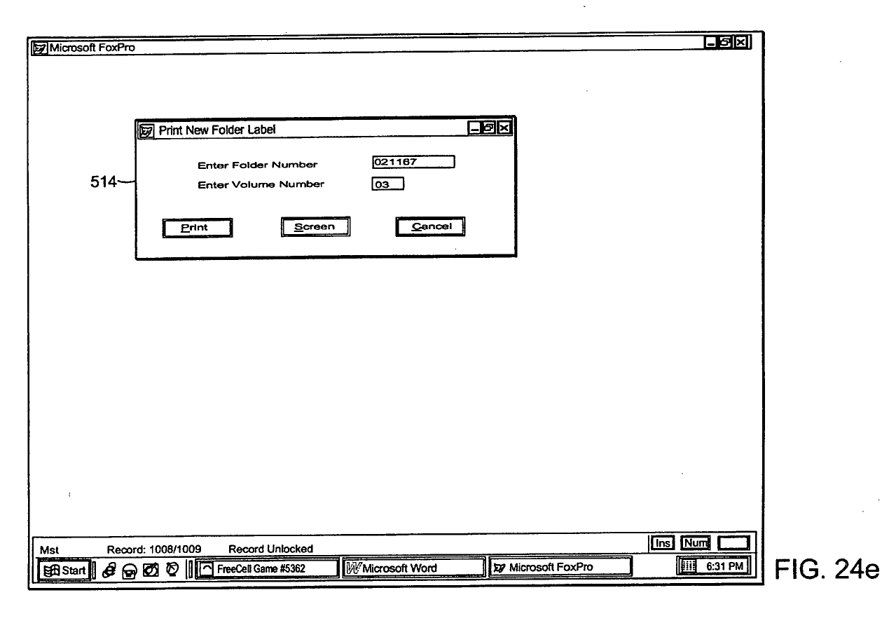

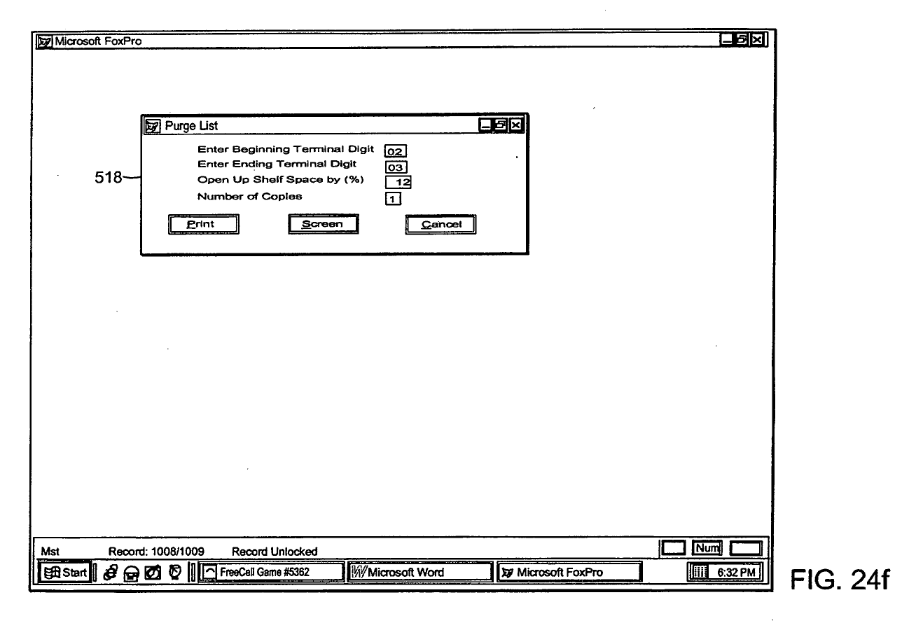

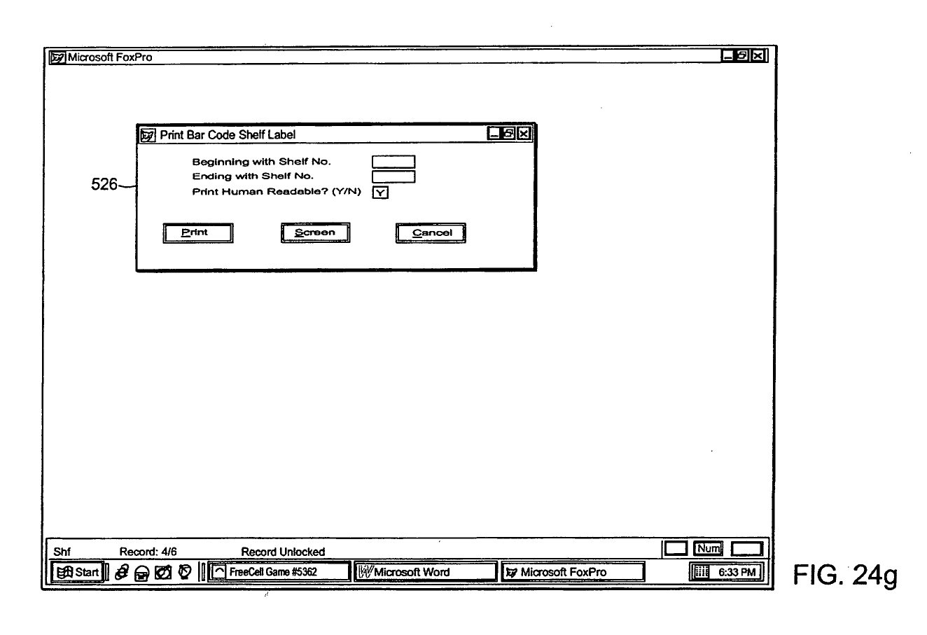

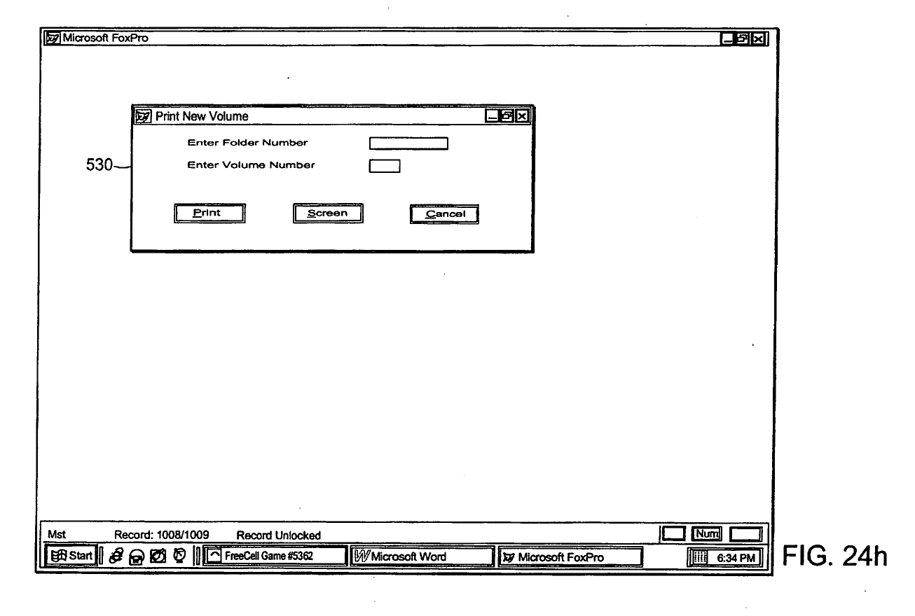

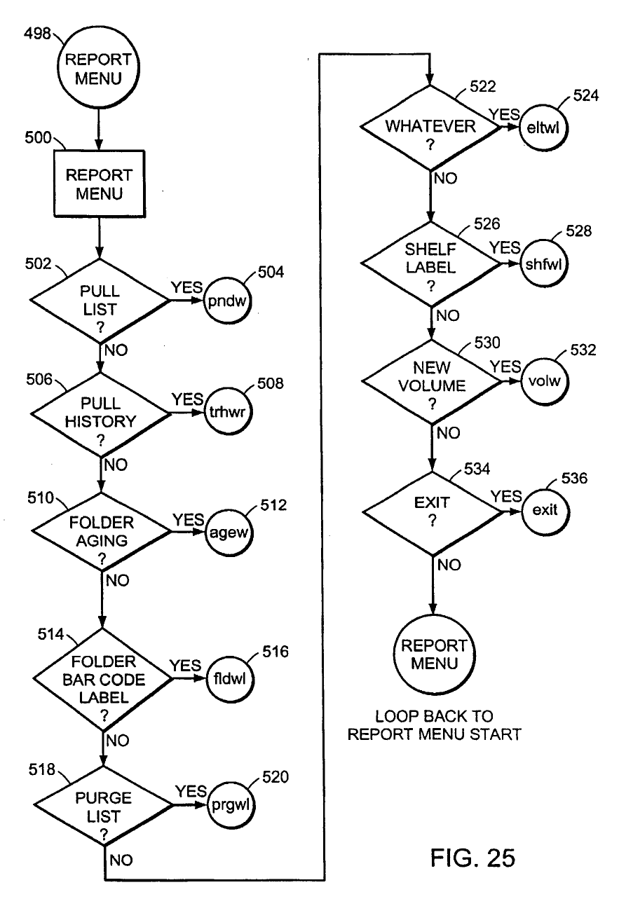

The print reports button 168 may call the subroutine RPTW 170, which allows the user to print reports, folder labels, shelf labels and new volume labels. An example of a print reports function is described with more particularity in connection with FIGS. 24 and 25.

The quit to windows button 172 may call the exit subroutine EXIT 174, which exits the shelf manager application.

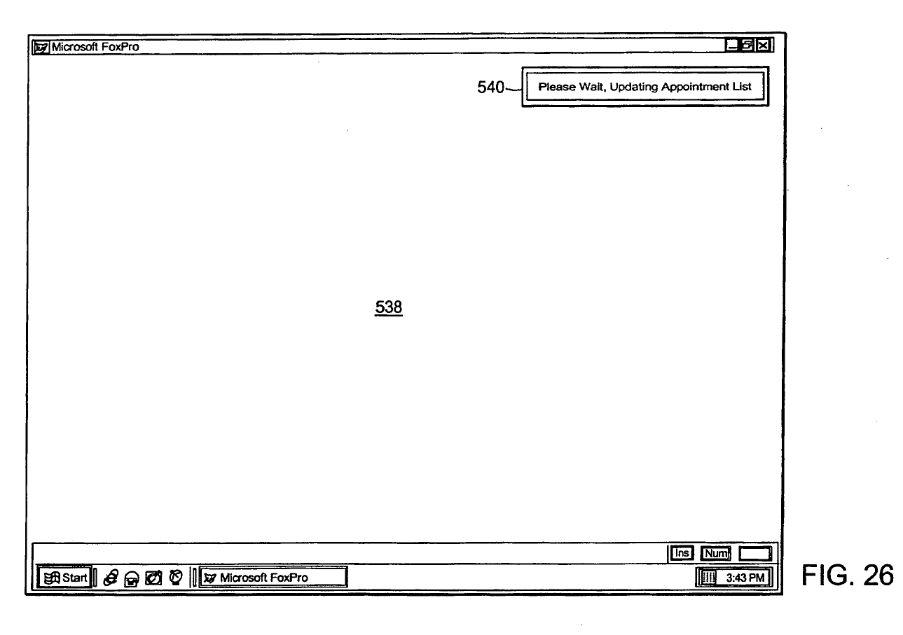

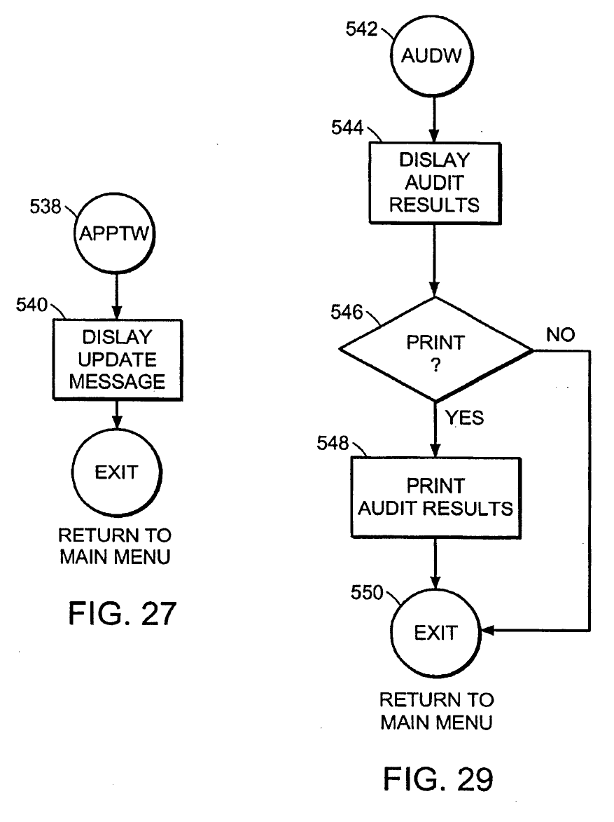

The appointments button 176 may call the appointment subroutine APPTW 178, which manually downloads any appointment information from the computer mainframe 40. An example of an appointments function is described with more particularity in connection with FIGS. 26 and 27.

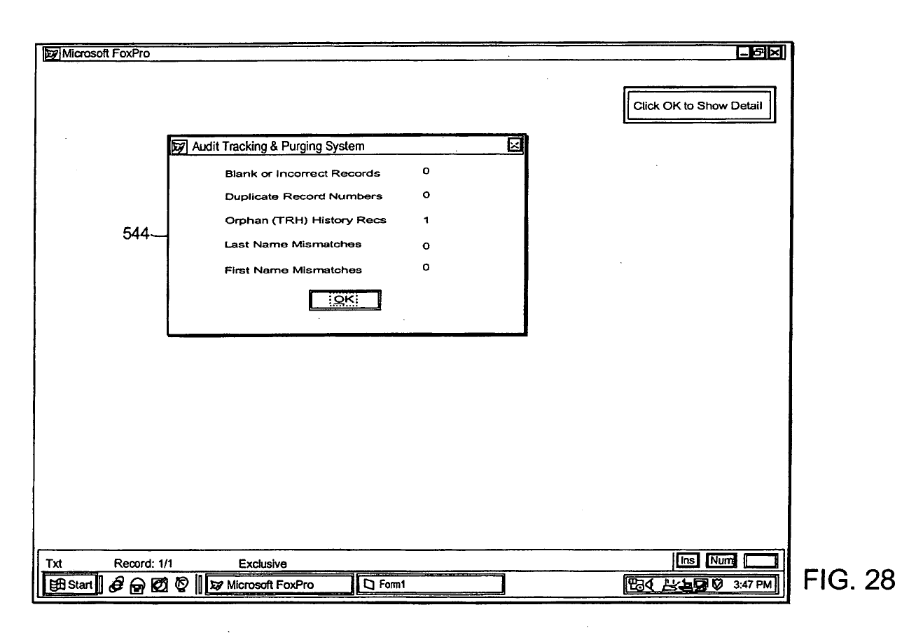

The audit system button 180 may call the import pull list subroutine AUDW 182, providing the with either a screen output of print output of errors detected is the database such as mismatched patient names and numbers. An example of an audit system button 180 is described with more particularity in connection with FIGS. 28 and 29.

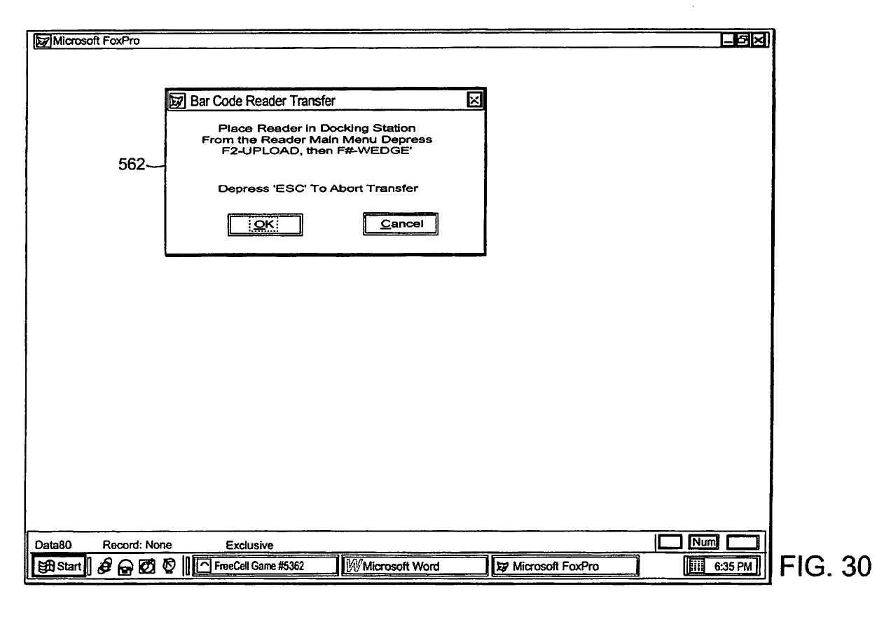

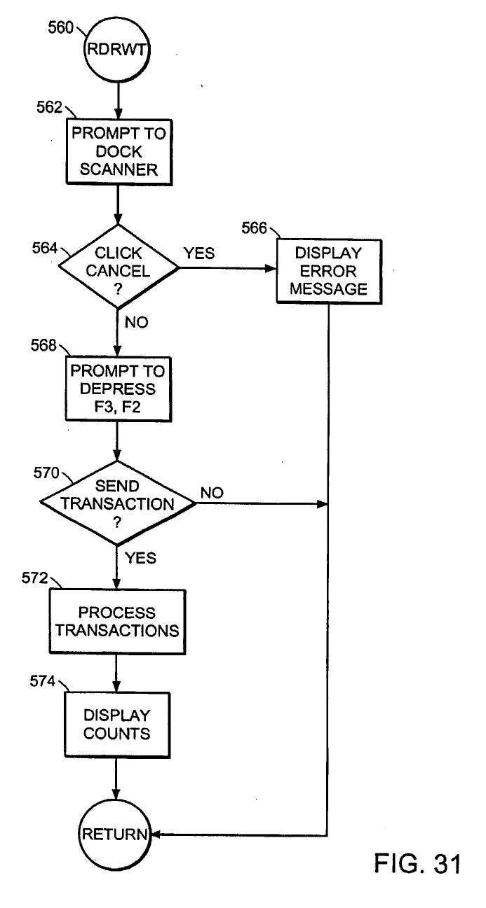

The remote scans button 184 may call the remote scans subroutine RDRWT 186, which allows the user to update the present location of folders logged out by using portable bar code readers. An example of a remote scans function is described with more particularity in connection with FIGS. 30 and 31.

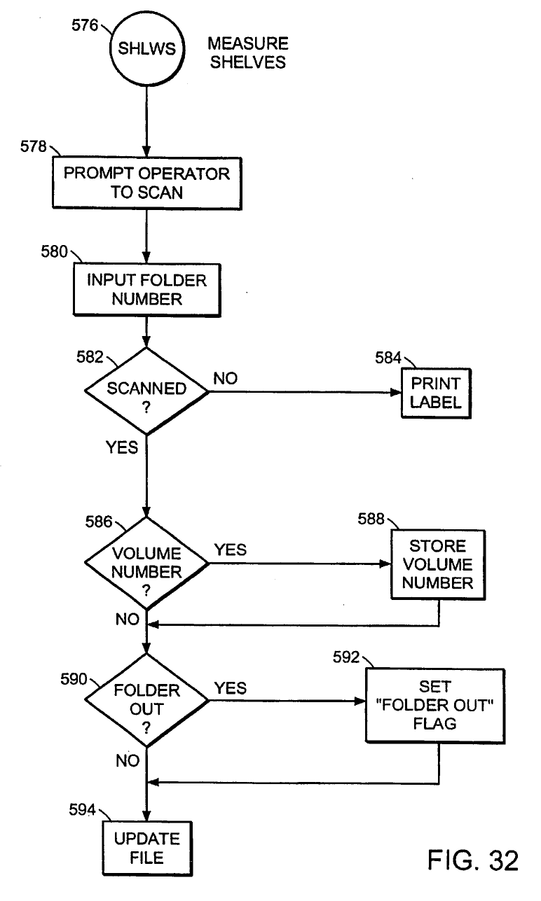

The measure shelf button 188 may call the measure shelves subroutine FLDWS 190, which allows the user to record, measure, label folders on each of the shelves. An example of a measure shelf function is described with more particularity in connection with FIG. 32.

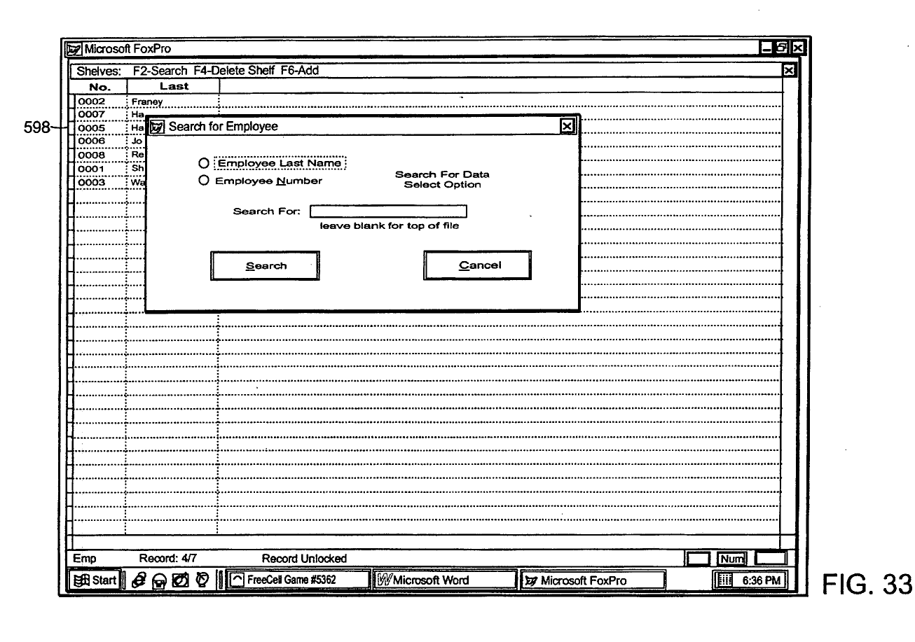

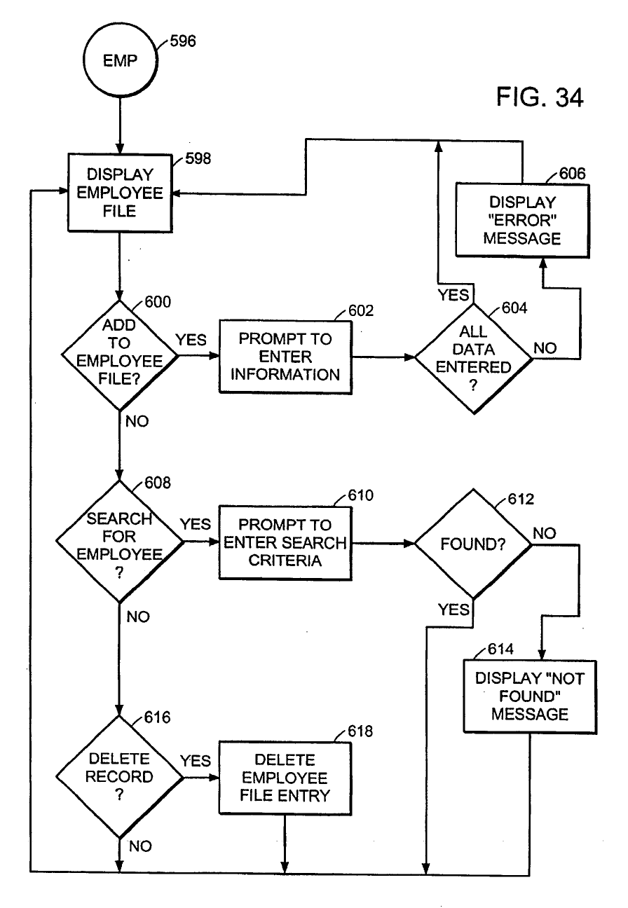

The add employees button 192 may call the add employee subroutine EMP 194, which allows the user to list all employees engaged in folder scanning along with their passwords. An example of an add employees function is described with more particularity in connection with FIGS. 33 and 34.

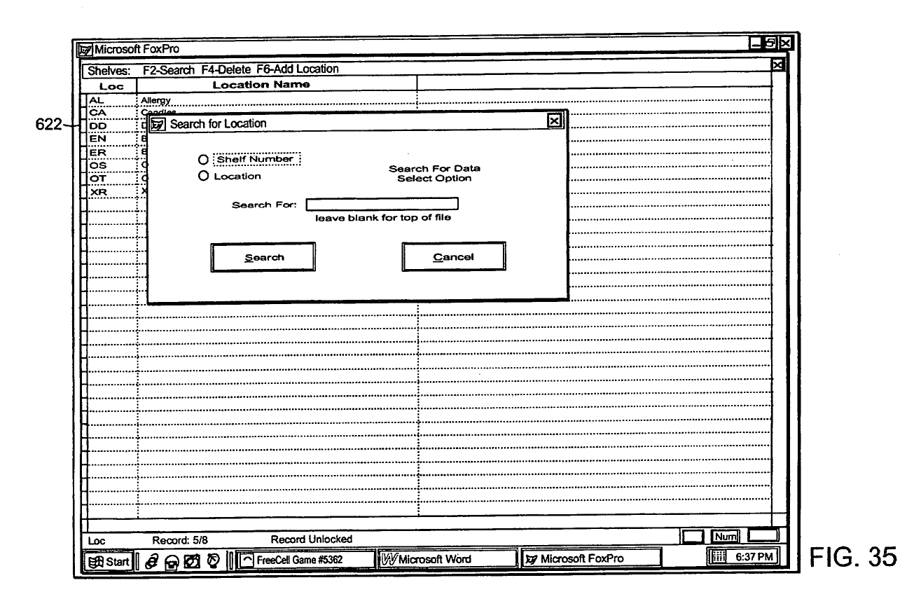

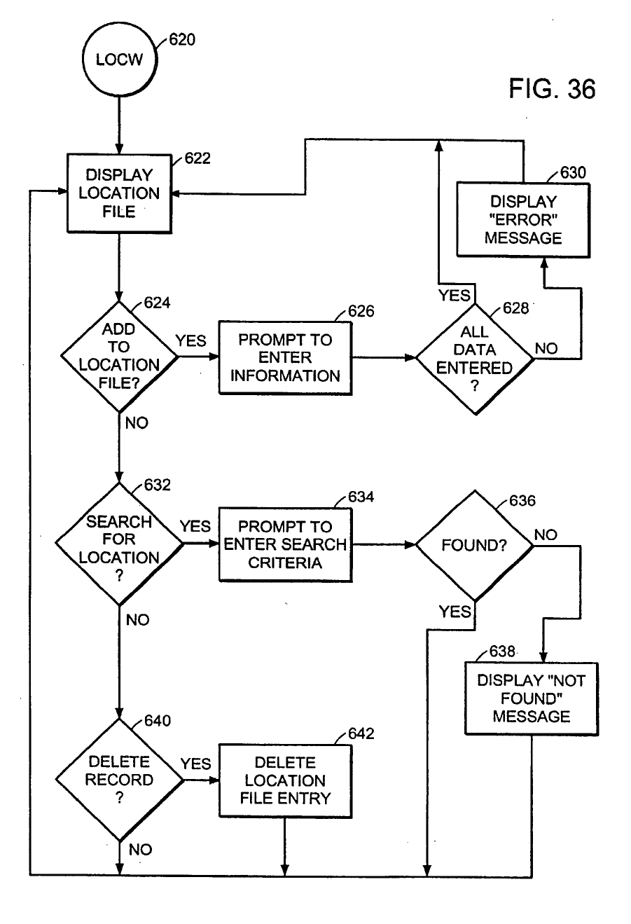

The add locations button 196 may call the add locations subroutine LOCW 198, which allows the user to enter the locations for logged-out files, including those in off-site locations. An example of an add locations function is described with more particularity in connection with FIGS. 35 and 36.

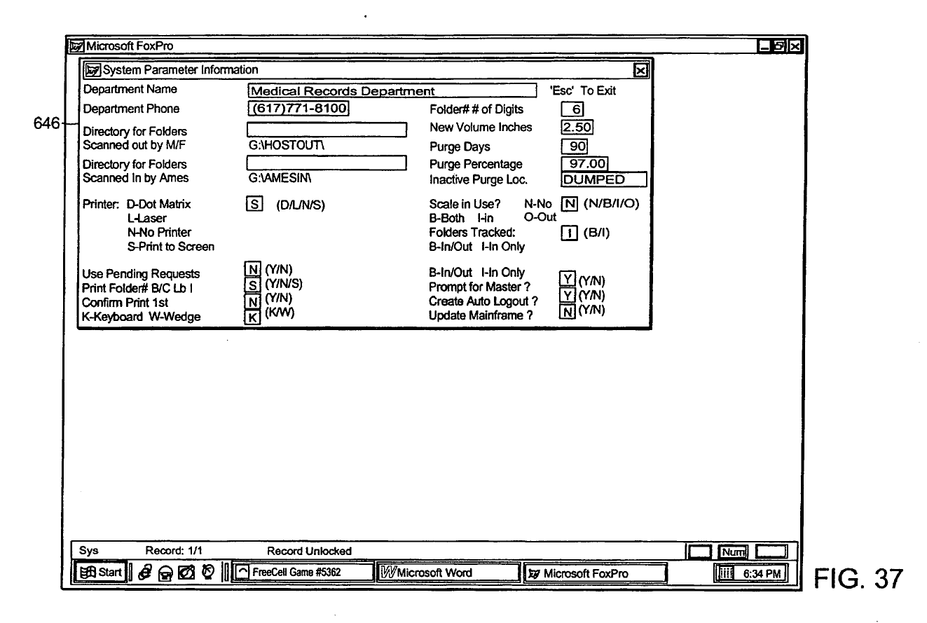

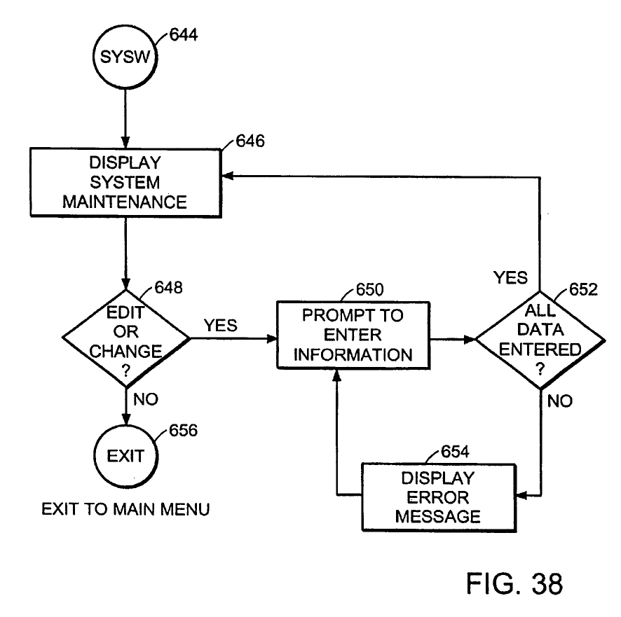

The system setup button 200 may call the system setup subroutine SYSW 202, which allows the user to set and modify the configuration parameters used by the system. An example of a system setup function is described with more particularity in connection with FIGS. 37 and 38.

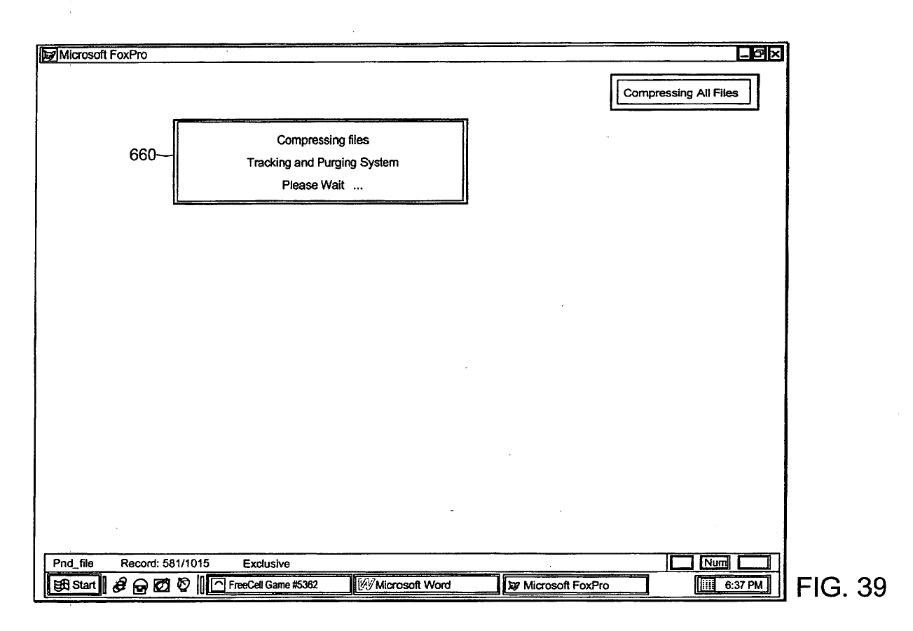

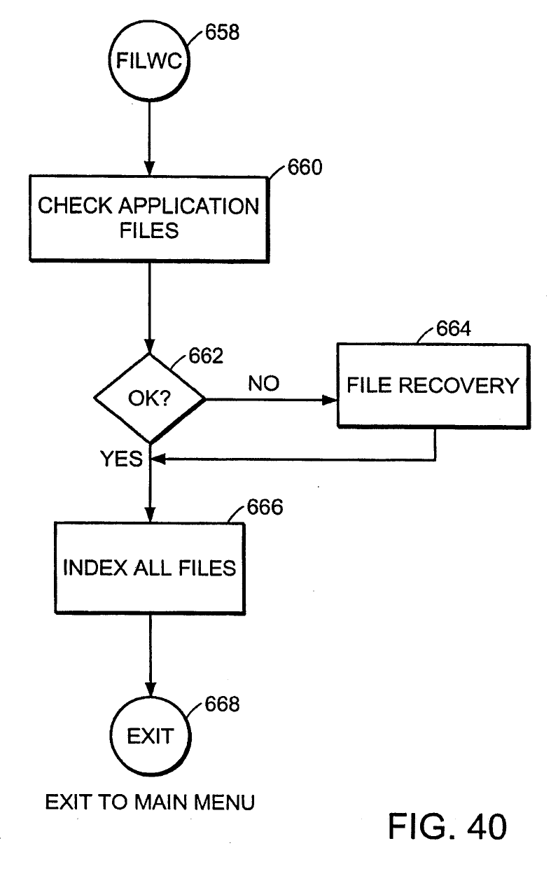

The compress button 204 may call the compress files subroutine FILWC 206, which is periodically used to reorganize and streamline all the application files. An example of a compress function is described with more particularity in connection with FIGS. 39 and 40.

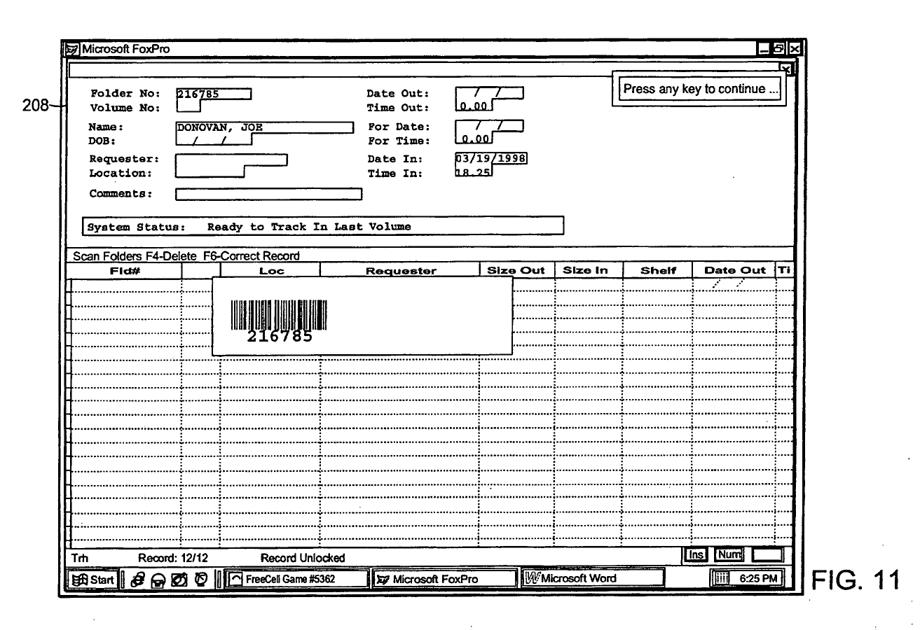

Turning now to FIGS. 11 and 12a-12e, an example of a scan folder subroutine is discussed in more detail. The scan folders subroutine may allow a user to log-out file folders to various locations and log-in the file folders back into the shelf manager system 10. The scan folders screen 208 may display folder specific information such as folder and volume number, patient name, folder size upon leaving and returning to the file room, the shelf number where the folder is stored, and various date-related information.

In operation, following the flowcharts in FIGS. 12a-12e, the log-out subroutine may begin with step 210, in which the program is waiting for a folder. The user may place a folder 52 on the electronic scale 130 and scan the bar code label 82 with the bar code reader 131 or alternatively enter a folder number and volume number via the keyboard 92. In steps 214 and 216, the program may determine if the folder was scanned; if not scanned, the system may set a flag. In step 216, as an option, a determination is made whether the file folder is the last volume, by scanning the volume number in step 218. If there is no volume number, the last volume flag may set in step 220, indicating that the file folder has only one volume. If there is volume number, the last volume flag may be reset in step 222. The volume number may be scanned in step 224, and the volume number may be stored in step 226.

For the folder number scanned from the bar code label 82 or entered via the keyboard 92, the system may compare the number in step 228 to valid file number criteria. If the file number is not valid, an error message may be returned to the screen 208.

Before a folder can be scanned, a determination may be made in step 232 whether there is a master record for the current file folder 52. If there is no master record, the user may be prompted in step 234 to enter basic master record information such as the patient's last and first name in step 235. If the master record was present, or if the information was not added in step 236 to the master at this time, the program may exit in step 237. If the master record was present in step 232, or if the information prompted for was entered, the information may be added in step 236, and the program may proceed to step 238 to process the folder in. Optionally, the system can automatically create a master file without operator intervention via the add auto step 240 and the add 242 step.

The program may have the provision of determining in step 244 if there is a computer mainframe, and if so, may update the master patient information in the mainframe in step 246.

The subroutine next may determine in step 248 if the folder has been logged or not. If the folder has not been logged, a determination may be made if there has been an auto log-out in step 250. If yes, the system may automatically create a logout 251. If no, the user may be prompted to enter logout information in step 252. If the information has not been properly entered in step 254, the program may exit in step 256. If the folder was logged in step 248 or if the information has been entered in response to the prompt, the shelf space field of the record may be updated in step 258.

The log-in part of the subroutine begins with step 260, where a determination may be made whether the file is being logged in. If the file is not being logged in, the program may exit in step 262. If the file is being logged in, the program may first lock all files in step 264 and retrieve the master file in step 266.

The next part of the subroutine directly concerns the weighing of the file folder 52 on the electronic scale 130 and the determination of the folder's size. First, in step 268, it may be determined if the scale 130 is in use, indicating that the file folder 52 is present. If the scale 130 is in use, the weight may be read in step 270. In step 272, a determination may be made whether the weight measurement is valid or whether an error occurred. If there was a weight error, an error message may be displayed in step 274 and the program may exit in step 276. If there is no weight error, the size of the file folder 52 may be calculated in step 278. The screen and record then may be updated with the next login data in step 280. If the scale 130 was not in use in step 268, the program may proceed directly to the update step 280.

The master file record next may be updated with the new size information in step 282, and if the shelf manager system 10 is connected to a computer mainframe 40, in step 284, the updated information may be downloaded to the mainframe in step 286.

The system next may proceed to print a bar code label if needed. First, in step 288, a determination may be made whether the bar code label printer 132 is in use, or ready to print a new label. In step 290, it may be determined whether the bar code for the file folder 52 had been scanned. If the bar code was not scanned, the assumption may be made that the file folder 52 requires bar code label to be printed, and the label may be printed in step 292 and the non-scanned flag reset in step 293.

In step 294, the file folder 52 may be checked for any pending requests, and if there are no pending requests, a determination may be made, in step 296, whether or not the folder 52 should be purged from active file storage 18. If the decision is made to purge, an off-site pending request may be created in step 298 and the program proceeds to step 306. If the determination is not to purge, the program may exit directly in step 300.

If there are pending requests, as determined in step 294, the file folder 52 may be logged out. The program may first determine in step 302 if there is more than one pending request; if there is, the operator may select the next logout request in step 304. After step 304, the program may determine if the files are locked in step 306. If the files are not locked, an error message may be displayed in step 308 and the programs again may exit at step 300. If all the files are locked in step 306, the program may proceed in step 310 to determine whether the scale 130 is in use, and if the weight on the scale is valid in step 312. If the weight is not valid, an error message may be displayed in step 314, and the program may exit in step 316. If the weight is valid, the size of the folder may be calculated in step 318. If the scale was not is use, or after completion of calculating the file size, the master file may be updated in step 322. In step 324, it may be determined whether the present file folder 52 needs a new folder. If a new folder is required, the system user may be alerted in step 326, so that the folder data may be properly supplied. Otherwise, a routing slip may be printed to accompany the file to the requestor's location. If the user manually inputs the folder number into the system via the keyboard, the system may print a new bar code label in step 332. In step 334 the scanned/volume flags may be reset, and the program may exit in step 336 to await a new folder transaction.

Turning now to the subject of file folder purging, it may be desirable to provide a shelf manager system 10 which keeps the active file storage 18 as nearly full as possible with files that have the highest probability of being requested. The purpose of this, as stated previously, may be to minimize the expensive transport of files, to and from the off-site storage facility 22.

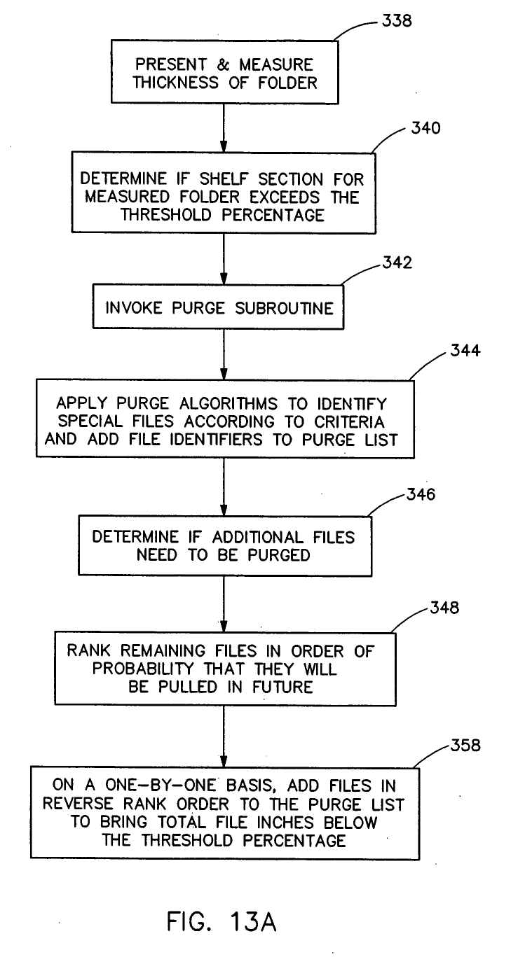

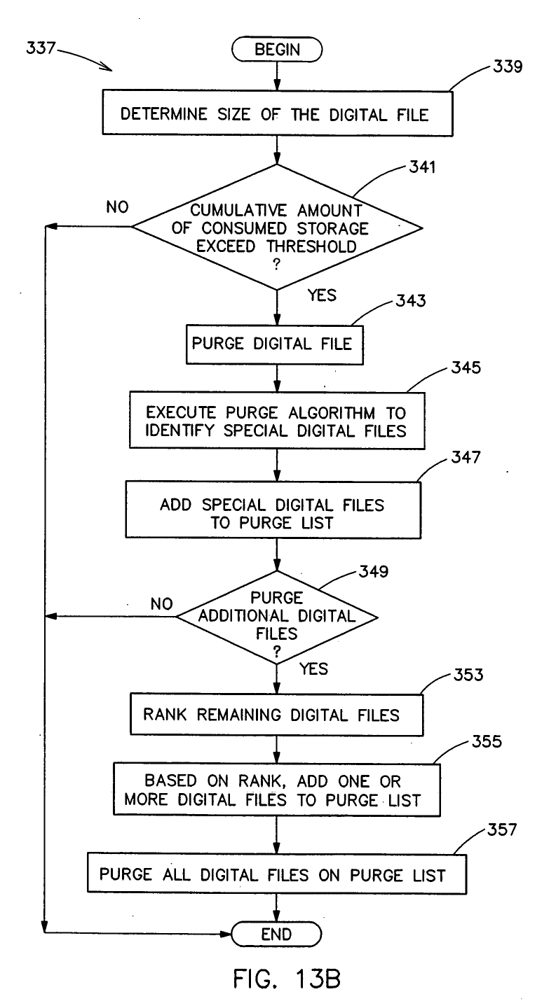

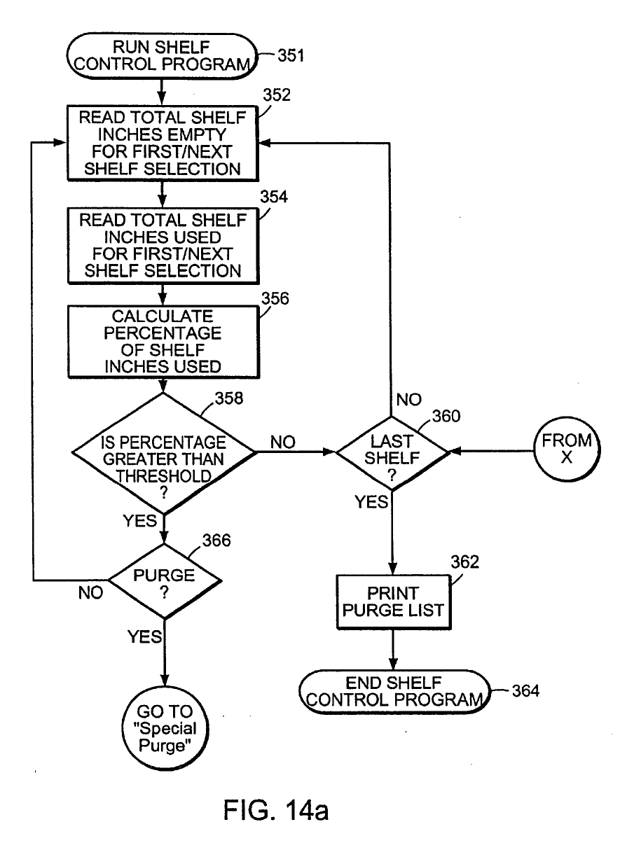

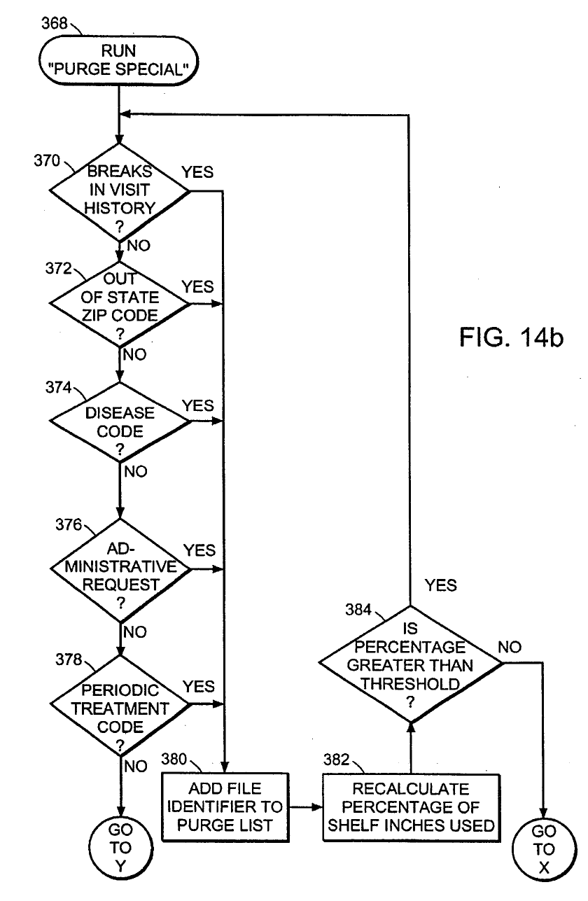

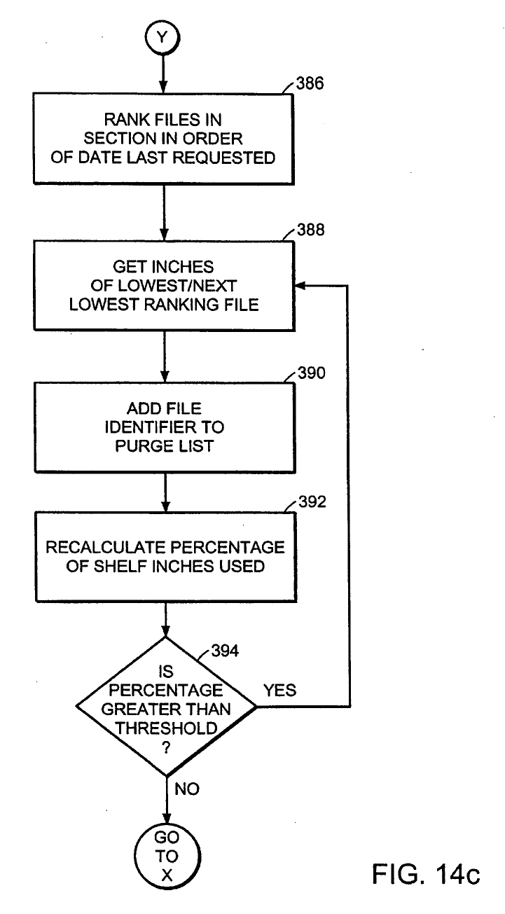

FIGS. 13A and 14a-14c describe an example of a purge program. The purge program may be performed in real time while scanning folders in or periodically, such as on a nightly basis. The purpose of the purge program is to determine whether any individual shelf subsections are more than a predetermined percentage full. To make this determination, the purge program may use the thickness data for each file folder 52 within a file subsection 54. As discussed previously, a purge program may look at each shelf subsection 54 independently to determine if a subsection is filled beyond its preset threshold value. If the threshold value is exceeded, the purge program may use file usage algorithms to remove the file folders 52 within a shelf subsection 54 that have the lowest probability of being requested in the future.

Initially, when an active file storage facility 18 is being set up for the first time to utilize the shelf manager system 10 of the present invention, an initial audit of the entire facility 18 may be conducted. During this audit, each shelf section may be measured. The total occupied inches of files for each section also may be measured for each middle digit section (1000 total), according to the terminal digit filing system discussed above. Thus, for each middle digit section, an occupied percentage of physical inches available may be initially established and mapped to the database of the shelf manager system 10.

FIG. 13A is an example of a generalized view of the file folder purging process as it occurs after the initial audit. Whenever a file folder 52 is logged-in via a logging station 128 in step 338, it may be weighed and its thickness determined. The shelf manager system 10 then may determine in step 340 if the threshold percentage for the file folder's subsection has been exceeded by the newly measured thickness for the file folder 52. This determination may be made by comparing the total file inches of all file folders in the subsection, including the newly logged-in file folder 52, to the available inches in the shelf subsection, and determining if the percentage full exceeds a threshold percentage, generally 90 to 95 percent, which can be set by the user. If the threshold has been exceeded for that folder's section, shelf manager 10 may automatically invoke the purge subroutine in step 342.

Once the purge subroutine has been invoked, the purge process may proceed in two stages. In the first stage, step 344, purging algorithms may be applied to all files in a section to identify certain “special files” which may be automatically added to the purge list. These special files may be identified according to criteria which establishes a low probability that the file will be requested in the future. Certain special criteria may be based on patterns in the patient's visit history, for example, including any of the following:

Breaks in Patient's Visit History—Five visits in the last two years followed by no visits in the last six months is generally indicative of a patient's death off-site, or a situation stabilized enough to not require further treatment at the facility, or a move to an alternative treatment center;

Distant Zip Codes—If patient's home zip code does not match any local zip codes, this may be indicative of a patient who was traveling and will not return for any subsequent visits;

Disease Codes—Certain disease codes, such as specific types of cancer, followed by no visits for a predetermined time period may be indicative of a patient's death off-site, or a move to an alternative treatment center;

Administrative requests—Non-diagnosis or non-treatment requests are generally one time only requests;

Periodic Treatment Codes—Certain treatments are periodic, such as annual mammography tests. The file folders should be purged to off-site storage 22 at the conclusion of the patient's visit and returned prior to the next scheduled exam; and

New Unit Numbers—Approximately five percent of new patients seen by a medical facility are chronically ill, thus leaving 95 percent of newly added patients as episodic and may therefore be safely removed after six months of inactivity.

In the second stage, in step 346, a determination may be made whether additional purging is required to bring the subsection percentage below the threshold value. If additional files need to be purged, all the remaining files in a shelf subsection 54 may be ranked in step 348 in order of the last time each was requested. The assumption is that the longer a file remains in active file storage 18, the higher the probability that it will be requested in the future. In step 350, files may be added in reverse rank order to the purge list, with the program recalculating the subsection percentage as each file is added to the list, until the subsection percentage is below the threshold setting for that subsection.

This process may be continued for all logged-in folders until all affected subsections exceeding the threshold percentages have been purged. A purge list then may be printed to be used as a guide to personnel who physically remove the files from the shelves. This process may occur until shelves fill to the threshold, which could result in a small group of folders being removed daily vs. the accepted practice of purging yearly.

It is contemplated that in some instances, a file purge may be conducted for all the sections in the file storage facility 16, at the same time or in succession. For example, if the user changed the threshold percentage from a higher to a lower number, (for example from 95 percent to 90 percent), to provide more space in all the shelf sections, the purge subroutine may be run for all shelf sections.

Turning to FIGS. 14a-14c, an example of a purge program is shown in more detail. In step 351, the purge program may be initiated. The total file inches for the first shelf subsection may be retrieved in step 352, and the total file inches used for that subsection may be retrieved in step 354. The percentage of shelf inches used then may be calculated in step 356. If it is determined that the threshold percentage is not exceeded, in step 358, the program may determine if other shelve subsections need to be tested for purging in step 360. If there are other shelf subsections, the program may go back to step 352; if not, the program may print the purge list in step 362 and end the purge program in step 364. However, if the threshold is exceeded in step 358, a determination may be made whether to purge in the shelf subsection in step 366. If the determination is not to purge, the program may go to step 352 and select data for the next shelf subsection; if the determination is to purge, the program may proceed to start the special purge with step 368.

As discussed in connection with FIG. 13A, if a file folder 54 meets certain special criteria, the determination may be made to immediately purge that file folder 54. In step 370, the file may be tested for breaks in patient visit history. In step 372, the file may be tested for out-of-state zip codes. In step 374, the file may be tested for specific disease codes that are episodic vs. chronic in nature. In step 376, the file may be tested for administrative requests. In step 378, the file may be tested for periodic treatment codes. If any of these tests are positive, the file identifier for that file may be added to the purge list in step 380, and the percentage of shelf inches used may be recalculated in step 382 followed by a determination of whether the percentage still exceeds the threshold in step 384. If the percentage does not exceed the threshold, the program may proceed to step 360 to choose the next shelf subsection.

If all the identified files have been added to the purge list, and the threshold is still exceeded, the program may proceed to step 386, where the files may be ranked in the order of the date last requested. In step 388, the inches for the lowest ranking file may be retrieved. The identifier for the lowest ranking file may be added to the purge list in step 390. In step 392, the percentage of shelf subsection inches used may be recalculated, and a determination may be made in step 394 if the percentage still exceeds the threshold for that subsection. If it does, the program may loop back and purge the next lowest ranking file. This procedure may continue until the shelf subsection percentage is below the threshold value; if the percentage does not exceed the threshold, the program may proceed to step 360 for the next shelf subsection.

The purging files criteria may be particularized for medical care files. However, the principles of the present invention are equally application to other file environments, as previously discussed. For example, in the banking industry the special criteria for purging mortgage files may include any of the following:

On-Time Loan Payments for a Predetermined Number of Months—Indicative of continual and reliable mortgage payments that are likely to continue and not require attention;

Deadbeats—Indicative of uncollectible loans, and more active file; and

Loan Repaid—Indicative of completed loan activity, where the file can be safely removed to off-site storage.

As another example, in the insurance industry the special criteria for purging insurance claim files may include either of the following:

Months Without Request since Claim Was Paid—This would be indicative of completed activity with regard to a claim; and

Settled Claims—Indicative of completed insurance claim activity, where the file can be safely removed to off-site storage.

As noted above, embodiments of the invention may be implemented with respect to digital files, such as, for example, digital files including medical records and/or digital images. For example, the file folder purging process and purge program illustrated above in relation to FIGS. 13A-14c, or parts or variations thereof, may be implemented in an analogous fashion for digital files, for example, as described below in relation to FIG. 13B. The term “purged” and derivatives thereof, when used herein in the context of digital files means to remove the files from a storage allocation, and may include storing it somewhere else (e.g., archiving the digital file).

Managing small digital files is often more efficient than managing larger ones. Further, for reasons similar to those set forth above with respect to storing paper files on-site or off-site, it is often beneficial to keep digital files most likely to be accessed in the future in local storage (e.g., on a server having a more direct and/or local connection to the computer(s) that access the files used to access the digital files) and purging digital files less likely to be accessed from local storage, which typically includes archiving them to a more remote storage location.

It should be appreciated that determining whether to purge digital files may be done irrespective of the types and/or formats of the digital files.

FIG. 13B is a flowchart illustrating an example of a method 337 of purging digital files from a storage allocation, according to some embodiments of the invention. When a digital file is created and/or checked into a storage allocation, its size (e.g., amount of memory consumed) may be determined in Act 339. Next, it may be determined in Act 341 whether adding the digital file to the storage allocation has increased a cumulative amount of consumed storage capacity above a particular threshold. If the threshold has been exceeded, then the digital file may be purged from the storage allocation in Act 343, for example, using any of the techniques described above in relation to FIGS. 13A and 14 a-c. Alternatively, rather than purging the digital file to be added, Acts 345, 347, 349, 353, 355 and 357 may be performed prior to adding the digital file to the storage allocation, and/or the digital file may first be added and then these acts performed.

In Act 345, one or more purge algorithms (e.g., any of those described above or others) then may be executed to identify any “special” digital files according to criteria that establishes a low probability that the file will be requested in the future, and these identified special digital files may be added to a purge list in Act 347. These criteria may include any of the criteria described above, for example.

Next, in Act 349, a determination may be made whether additional purging of digital files is necessary to bring the cumulative amount of consumed storage space in the storage allocation below a threshold value. If it is determined that such purging is necessary, in Act 353, all of the remaining digital files (e.g., those that were not already added to the purge list) may be ranked in an order, such as according to a last time each digital file was accessed. For example, a file most recently accessed may be given a highest rank at the beginning of the order, and a digital file least recently accessed may be given a lowest rank at the end of the order.

In Act 355, starting at the beginning of the order (e.g., at the most recently accessed digital file), one or more digital files may be added to the purge list in order, with the cumulative amount of consumed storage space recalculated each time a digital file is added to the list, until the amount of consumed storage space is below the threshold value. All of the digital files listed on the purge list then may be purged from the storage allocation in Act 357. It should be appreciated that, in some embodiments, each digital file may be purged from the storage allocation as soon as it is determined that the file is to be purged, as opposed to first creating a purge list and then purging all the digital files included in the purge list. In such embodiments, the cumulative amount of consumed storage space may be re-calculated each time a digital file is purged, until the consumed storage space is below the threshold value.

As noted above, purging digital files may involve moving them to a different storage location, e.g., archiving the digital files and/or storing the digital files offsite. In such embodiments, there may be a choice of storage locations, and one or more of the storage locations may be selected for storage. This selection may be based, at least in part, on the cost of storing the purged files(s) at each eligible storage location, and the most cost-effective storage location for the purging event may be selected. Further, in some embodiments, the storage to which a purged file is moved is cheaper storage than the storage allocation from which it was purged.

Although method 337 has been described above in response to a digital file being created and/or checked into a storage allocation, the invention is not so limited. Method 337 may be performed at any of a variety of times such as, for example, periodically or in response to a user request.

One or more acts of method 337 described in relation to FIG. 13B and any of the methods described in relation to FIGS. 10a,b, 12a-e, 13A, 14a-c, 16, 19, 21, 23, 25, 27, 29, 31, 32, 34, 36, 38 and 40, and various embodiments and variations of these methods and these acts, individually or in combination, may be defined by computer-readable signals tangibly embodied on one or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., in relation to the methods listed above, or any acts thereof), and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of the systems described in relation to any of FIGS. 1, 5-8 and 42-44, may be distributed across one or more of such components, and may be in transition therebetween.

The computer-readable media may be transportable such that the instructions stored thereon can be loaded onto any computer system resource to implement aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described in relation to any of FIGS. 1, 5-8 and 42-44, that perform the functions described herein can be generically considered as one or more controllers that control such functions. For example, any of the systems described in relation to FIGS. 1, 5-8 and 42-44 may include a storage controller configured (e.g., programmed) to perform one or more of the function described herein, including any of the acts described above in relation to FIGS. 13A, 13B, 14a-c and the other methods described herein. The one or more controllers can be implemented in numerous ways, such as with dedicated hardware and/or firmware, using a processor that is programmed using microcode or software to perform the functions recited above or any suitable combination of the foregoing.

Referring now to FIGS. 15 and 16, examples of a Pending Requests user screen and flowchart are shown. The pending request subroutine is used for tracking requests for file folders. In step 398, the pending request subroutine PNDW may be initiated, causing the pending requests screen to be displayed in step 400. In step 402, the user may choose to add information to the pending request file, and may be prompted to do so in step 404. When all needed data has been entered, in step 406, the program may return to step 400; or if the information is not entered, an error message may be displayed in step 408. In step 410, the user may choose to search for a pending request and may be prompted to enter search criteria in step 410. If the data is found, it may be displayed in step 414. If it is not found, a “Not Found” message may be displayed in step 416. The user also may choose to delete a pending request entry in step 418 and carry out the deletion in step 420.

Referring now to FIGS. 17 through 19, examples of Folders Master user screens and a flowchart are shown. The folders master contains the basic information about a file folder such as, for example, the last time logged out, the date logged out, requester, location, as well as other information. In step 426, the folders master subroutine MSTW may be initiated, causing the folder master screen to be displayed in step 428. In step 430, the user may choose to add information to the master file and may be prompted to do so in step 432. When all needed data has been entered, in step 434, the program may return to step 400, or if the information is not entered, an error message may be displayed in step 436. In step 438, the user may choose to search for a master record and may be prompted to enter search criteria in step 440. If the data is found, it may be displayed in step 442. If it is not found, a “Not Found” message may be displayed in step 444. The user also may choose to delete a master file entry in step 446 and carry out the deletion in step 448.

Turning now to FIGS. 20 and 21, examples of a Log-Ins & Log-Outs History user screen and flowchart are shown. The log-ins & log-outs history provides a history record of activity associated with a file folder 54. In step 452, the log-Ins & log-out history subroutine TRHWD may be initiated, causing the log-ins & log-outs history screen to be displayed in step 454. In step 456, the user may choose to correct information in the log-ins & log-outs history file and may be prompted to do so in step 458. When all needed data has been entered, in step 460, the program may return to step 454, or if the information is not entered, an error message may be displayed in step 462. In step 464, the user may choose to search for a log-ins & log-outs history record, and may be prompted to enter search criteria in step 466. If the data is found, it may be displayed in step 468. If it is not found, a “Not Found” message may be displayed in step 470.

Referring to FIGS. 22 through 23, example of Shelf Space user screens and a flowchart are shown. The shelf space screen provides information on shelves including, for example, shelf size, shelf location, inches used, and percent used. In step 474, shelf space subroutine SHFW may be initiated, causing the shelf space screen to be displayed in step 476. In step 478, the user may choose to add information to the shelf file and may be prompted to do so in step 480. When all needed data has been entered, in step 482, the program may return to step 476, or if the information is not entered, an error message may be displayed in step 484. In step 486, the user may choose to search for a shelf entry and may be prompted to enter search criteria in step 488. If the data is found, it may be displayed in step 490. If it is not found, a “Not Found” message may be displayed in step 492. The user also may choose to delete a shelf file entry in step 494 and carry out the deletion in step 496.

FIGS. 24a-24h and FIG. 25 illustrate examples of user screens and a flowchart for the Print Reports Subroutine. The print reports menu is used to print reports, folder labels, shelf labels and new volume labels. In step 498, the REPORT MENU subroutine may be initiated, causing the report menu screen to be displayed. The report menu screen may give the user several options for printing reports. The user may choose to print a pull list in step 502, which may initiate the print subroutine PNDW in step 504. The user may choose to print a pull history in step 506, which may initiate the print subroutine TRHWR in step 508. The user may choose to print a folder aging report, which shows the age of scanned out files in step 510, which may initiate the print subroutine AGEW in step 512. The user may choose to print a file folder bar code label in step 514, which may initiate the print subroutine FLDWL in step 516. The user may choose to print a purge list in step 518 which may initiate the print subroutine PRGWL in step 520. The steps 522 and 524 may be steps reserved for future expansion that are not currently used. The user may chose to print a shelf label in step 526, which may initiate the print subroutine SHFWL in step 528. The user may choose to print the labels for a new file folder volume in step 530, which may initiate the print subroutine VOLW in step 532. Finally, the user may choose to exit the report menu in step 534, which may initiate the exit function EXIT in step 536.

FIGS. 26 and 27 show examples of a user screen and a flowchart for the Appointments subroutine APPTW. The updating of appointments can occur either automatically or periodically from the computer mainframe 40, or manually by selecting the Appointments button 176 on the Main Menu. While the shelf manager 10 is being updated with new appointments from the computer mainframe 40, a message box may be displayed on the display screen 91. No user interaction is required while this process takes place.

FIGS. 28 and 29 show examples of a user screen and flowchart for the Audit System subroutine AUDW. In step 542, the audit system subroutine may be initiated, causing an audit of the entire database 126, in which certain types of data errors may be identified, such as blank and incorrect records and various data mismatches. A screen prompt 544 may present a summary of the audit results. By clicking on a screen prompt, the audit details may be displayed on the screen 91. The user then may have the choice in step 546 of printing out the audit details in step 548 or exiting in step 550.

Turning now to FIGS. 30 and 31, examples of a Remote Scans user screen and flowchart are shown. The remote scan function allows a user to update the location of a file folder 52 by using a portable bar code scanner, which may record scans to be later uploaded into the shelf manager system 10. In step 560, the remote scans subroutine RDRWT may be initiated, causing a screen prompt to dock the scanner to be displayed in step 562. In step 564, the program may be canceled by the user causing the error message in step 566 to be displayed. In step 568, the user may be prompted to initiate the uploading of the data and send the transaction in step 570 to the computer 88. The transaction may be processed by the computer 88 in step 572 and the updated file data may be displayed in step 574.

Referring now to FIG. 32, an example of a Measure Shelves flowchart is shown. The measure shelves subroutine allows the user to record, measure, and label folders on each of the shelves. In step 576, the measure shelves SHLWS may be initiated, causing the scan prompt to be displayed in step 578. The folder number may be input in step 582. If the file folder was not scanned in step 582, indicating that there is no label, a label may be printed in step 584. If the file has a volume number in step 586, the volume number may be stored in step 588. If there is no volume number, the file may be considered to be a single file folder. In step 590, the user may indicate if the file folder is in-file or out-of-file. If the file is out, the “folder out” flag may be set in step 592. If the folder is in, the file may be updated in step 594, and the user operator may be prompted to scan the folder.

Referring now to FIGS. 33 and 34, examples of an Add Employee user screen and flowchart are shown. The add employee subroutine allows the user to list all employees engaged in folder scanning along with their passwords. In step 596, the Add Employee subroutine EMP may be initiated, causing the add employee screen to be displayed in step 598. In step 600, the user may choose to add information to the employee file, and may be prompted to do so in step 602. When all needed data has been entered, in step 604, the program may return to step 598, or if the information is not entered, an error message may be displayed in step 606. In step 608, the user may choose to search for an employee record, and may be prompted to enter search criteria in step 610. If the data is found, it may be displayed in step 612. If it is not found, a “Not Found” message may be displayed in step 614. The user also may choose to delete an employee file entry in step 616 and carry out the deletion in step 618.

Turning to FIGS. 35 and 36, examples of Add Locations user screens and a flowchart are shown. The add locations subroutine allows the user to enter the locations for logged-out files, which may include those in off-site locations. In step 620, the add locations subroutine LOCW may be initiated, causing the add locations to be displayed in step 622. In step 624, the user may choose to add information to the location file, and may be prompted to do so in step 626. When all needed data has been entered, in step 628, the program may return to step 622, or if the information is not entered, an error message may be displayed in step 630. In step 632, the user may choose to search for a location file entry and may be prompted to enter search criteria in step 634. If the data is found, it may be displayed in step 636. If it is not found, a “Not Found” message may be displayed in step 638. The user may also choose to delete a location file entry in step 640 and carry out the deletion in step 642.

Referring to FIGS. 37 and 38, examples of a System Setup user screen and flowchart are shown. The system setup subroutine allows the user to set and modify the configuration parameters used by the shelf manager system 10. In step 644, the system setup subroutine SYSW may be initiated, causing the system setup screen to be displayed in step 646. In step 648, the user may choose to edit or change system parameters, and may be prompted to do so in step 650. When all the data has been entered, in step 652, the program may return to step 646. If the information is not entered, an error message may be displayed in step 654. If the decision is not to change the system setup information, the programs may exit in step 656.

Now, turning to FIGS. 39 and 40, examples of a compress file user screen and flowchart are shown. The compress file function is used periodically to reorganize and streamline all the application files. In step 658, the compress files subroutine FILWC may be initiated, causing the “check application” prompt to be displayed in step 660, as the files are checked. If the files are deemed to be damaged in step 662, a file recovery procedure may be run in step 664. If the files are not-damaged, all files may be indexed in step 666, and upon completion, the program may exit in step 668.

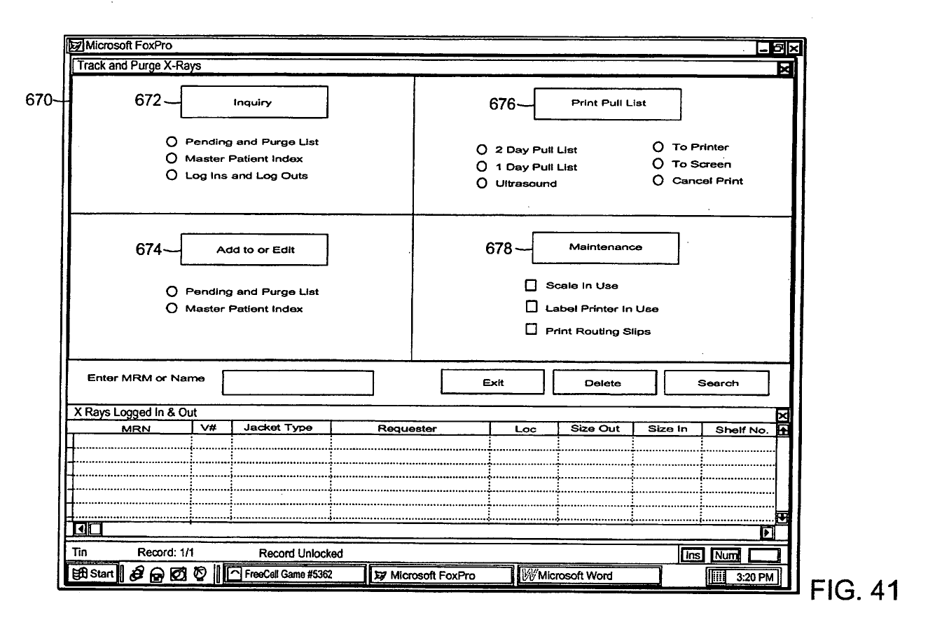

FIG. 41 shows an example of a graphical user interface screen 670 for use with the present invention, which allows the user to search for or to add file data associated with x-ray film jackets. The screen 670 displays log-in and log-out data for various x-ray jacket types, which may have different jacket thicknesses when empty. The screen 670 is divided into a plurality of functional sections. The inquiry section 672 may enable the user to display pending and purge lists, the master patient index, and the log-in and log-outs. The add to or edit section 674 may enable the user to enter or edit pending and purge lists as well as the master patient index. The print pull list section 676 allows the user to print out a pull list or display it on the monitor screen 91. The maintenance section 678 may enable the user to print routing slips as well as perform maintenance operations associated with the electronic scale 130 and the label printer 132.

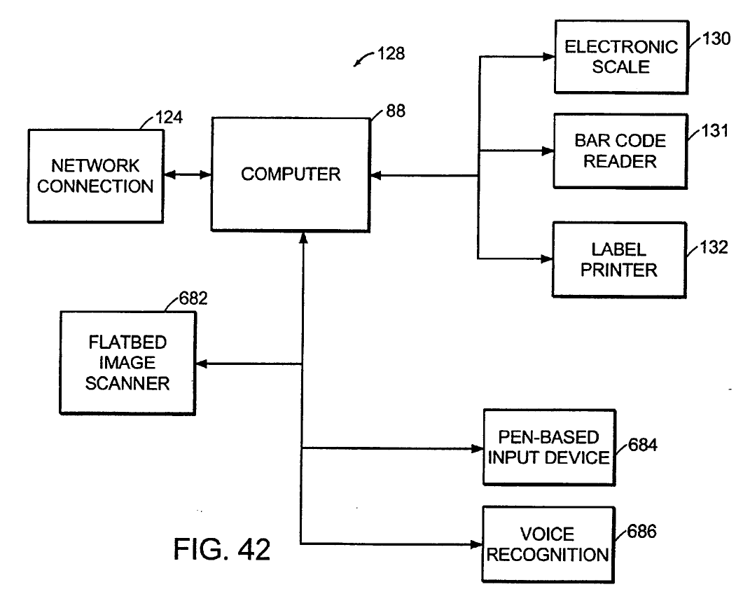

Turning now to FIG. 42, another embodiment of the present invention is shown. As discussed above, the shelf manager system 10 of the present invention may be configured to track multiple file requests for active files. Multiple requests can arise when different medical departments in a patient medical care facility 14 need to see the same patient's file.

It is often the case that a medical file is requested simultaneously by different clinical departments within the medical care facility 14. For example, pertinent parts of a patient's medical records may need to be reviewed by both the radiology department 26 and the pathology departments 28. Because there is typically only one paper copy of a patient's file, these two requests would need to be filled serially by sending the paper file to the first department and then to the second. The second requesting department will need to wait until the first department is finished with the patient's file and re-routed to the second requesting department. This can be a serious drawback in the case of a patient who is undergoing treatment by the first and second department.

In some embodiments of the present invention, a patient's file folder 52 is supplemented by providing electronic or paper copies of the files to each of the requesting departments so that both the first requesting department and the second requesting department can review the file, or pertinent parts of the file, concurrently rather than serially.

Such embodiments, an example of which is illustrated in FIG. 42, may be described as intelligent imaging. The system may include a modified logging station 128, which may include a computer system 88, an electronic scale 130, a bar code reader 131, a label printer 132, and a network connection 124. In addition, the logging station 128 may include a flatbed image scanner 682, which may be used to scan pages of documents into the computer system, so that they may be provided to the requesting department in electronic form or printed out in paper form.

In such embodiments, a patient file 52 may be selectively scanned. It has been recognized that some parts of a patient's file are more pertinent than other parts, and it may be only these parts that need to be scanned and duplicated. Typically the pertinent parts of a patient's file are a subset or abstract of the total information the file contains. In the case of a medical care facility 14, the scanned information may be limited to clinical information and lab results, if not already available in electronic form, and information needed by doctors and other medical personnel to carry on medical diagnostic work for a patient. The pertinent information may be scanned and stored in an electronic data base, and may be reproduced and duplicated at the time the request is made.

The logging optionally, a pen-based input device 684. With the pen-based input device 684, handwritten annotations may be made to the electronic copies of the files. The logging station 128 also may include a voice recognition interface 686 so that voice annotations could be likewise made to the documents. The basic document pages, along with their various pen and voice annotations, may be described as hybrid documents.

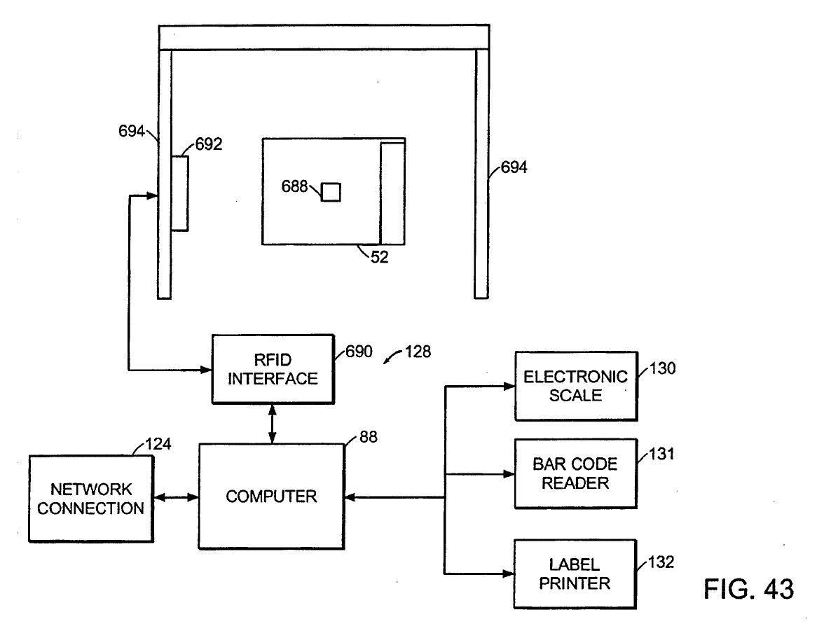

Now, turning to FIG. 43, another embodiment of the present invention is shown. In this embodiment, the file folders are fabricated with implanted radio-frequency identification tags to automatically identify each file 52 when it passes close to a radio frequency identification reader embedded in a doorway detection system.

Radio frequency identification tags in such an embodiment may be of the type manufactured by Texas Instruments of Dallas, Tex. The basic RFID tag may include a thin microelectronic memory and control transponder chip surrounded by a flat antenna wire. Power and data may be provided to the chip by an RFID reader, emitting a modulated radio frequency field which powers the chip by field induction and reads or writes data to the chip, as needed. The RFID tag thus may store the same information provided by a bar code label to efficiently identify a file when it is in close proximity to a RFID reader. In this embodiment, the information written and read out of the RFID tag may represent the patient Identification number, which is linked to the patient's master record.

In FIG. 43, the file folder 52 includes a RFID tag 688. In this embodiment, the RFID tag 688 may be affixed to the file folder 52 in the manufacturing process by inserting the RFID tag 688 between the glued seams of a reinforced double-sided file folder 52.

FIG. 43 shows a logging station 128, including any of: a computer 88, an electronic scale 130, a bar code reader 131, a label printer 132, and a network connection 124. Additionally, the logging station 128 may include an RFID interface 690.

The RFID tag 688 may communicate by means of an RFID reader 692, shown schematically as being mounted in a door frame 694. The RFID interface 690 may receive identification information from the RFID reader 692 for input into the shelf manager system 10. This embodiment may operate the same way as other embodiments described above, except that the RFID tag 688 and reader 692 may take the place of the bar-code label 82 and the bar code reader 131 in identifying files that are being moved through the door frame 694, one at a time or in bulk. Also, the system may have the capability of writing identification information into the RFID tags of new files, taking the place of the bar-code label printer 132. Passive tracking of file folders or x-ray jackets is provided without the operator needing to pick up a scanner 134 and actively scan the file or x-ray jacket into or out of the active file storage 18.

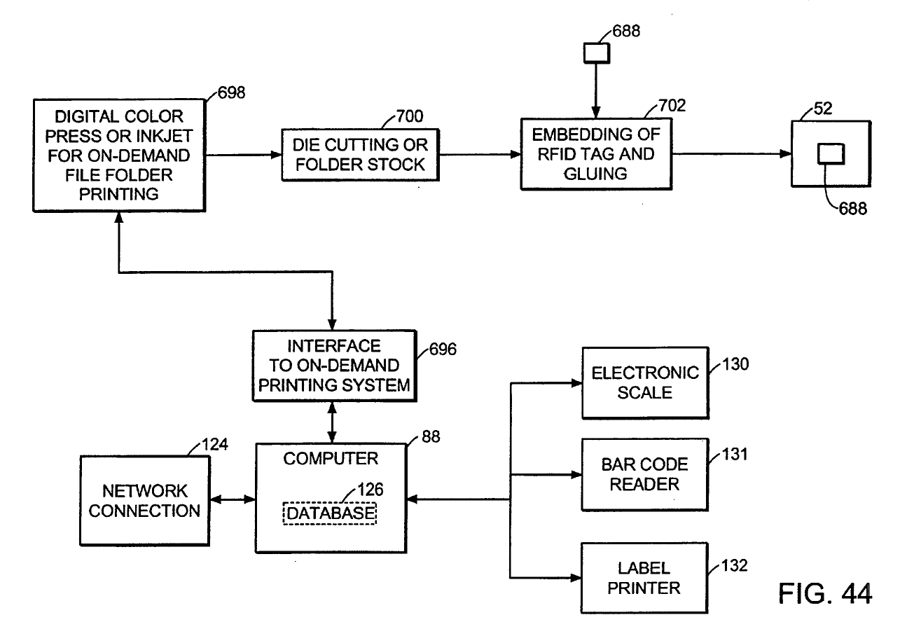

Another embodiment of the present invention will now be described in connection with FIG. 44, which utilizes an on-demand digital color printing system to create new color-coded file folders for use with the shelf manager system 10, as needed. This embodiment overcomes the inefficiencies of maintaining large inventories of blank file folders. In known systems, color-coded labels 74 are typically affixed to the blank files, and bar-coded information and patient identification information must be added at the appropriate time. With the system of this embodiment, the file folders may be created as needed, and can be created in completely finished form in advance of a patient's first visit to the medical center 12.

FIG. 44 shows an example of a logging station 128, which may include any of: a computer 88, an electronic scale 130, a bar code reader 131, a label printer 132, and a network connection 124. The logging station 128 also may include an interface 696 to an on-demand printing system.

In the manufacture of file folders 52, according to the present embodiment, a blank file folder may be printed on a digital color press 698 from data stored in the database 126 of the shelf manager system 10.

The file folder 52 may be printed to include any of: the color coding, the bar code label, and patient name received through interface 696 from the computer 88, based on patient record information included in the database 126 or from a central medical database 42. Printing occurs directly on the file folder substrate 63, shown in FIG. 4. Printing on the file folder 52, in step 698, may be accomplished by a digital color press of the type manufactured by Indigo Nev. of Maastricht, The Netherlands, which utilizes liquid toner for high speed color printing for the CMYK color printing process to create the colors. Alternatively, an industrial color inkjet printer may be used, such as a Model 2001 Graphics Printing System available from Videojet Systems International, Inc. of Wood Dale, Ill. This color inkjet printing system uses up to 40 print heads to produce 10 colors in four positions for printing color file folders, file pockets, or x-ray jackets directly on the substrate. The color inkjet printer provides additional cost savings over the digital press by requiring less ink to produce each file folder 52. Both of these printing methods may be used to create file folders 52 which are color-coded for the terminal digit filing system earlier described.

The die cutting of the folder stock may occur at step 700. In the next step 702, the folder 52 may be glued and, optionally, an RFID tag 688 may be inserted.

A method of controlling the printing of labels is described in U.S. Pat. Nos. 4,939,674 and 5,621,864 to Price et al., which are hereby incorporated by reference. The teachings of the Price et al. patents may be used within embodiments of the invention for its teaching of the automatic generation of indicia fields and formatting. However, as stated above, in some embodiments of the invention, direct printing on the file-folder substrate 63 is employed rather than printed labels as described in the Price et al. patents.

With the system shown in FIG. 44, the completed file folder 52 may be created as needed, complete with all proper color coding, bar coding, and patient information, along with the embedded RFID tag 688, if desired. In addition, since there are no labels, the traditional step of adding labels is eliminated, providing a manufacturing cost savings. Also, since the file folders 52 do not require labels, the thickness of the file folder tabs 70 may be reduced, providing greater file storage density on the shelf units 46. Finally, the file folders 52 lasts longer, due to reduced wear. In conventional labels folders, the stick-on labels 74 have a tendency to rub against each other as the file folders 52 are filed and re-filed on the shelf units 46, causing wear and reducing the active life of the file folders 52.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of managing storage capacity on at least a portion of one or more computer-readable media having stored thereon a plurality of digital files, comprising computer-implemented acts of:
(A) determining whether an amount of storage space consumed by said plurality of digital files has reached a threshold value; and
(B) if the threshold value has been reached:
(1) selecting one or more digital files of the plurality for removal from said media based, at least in part, on a likelihood that the one or more digital files will be requested by a user in the future and not solely on an amount of time that has elapsed since the one or more digital files was created or last accessed, and
(2) removing the one or more selected digital files from the media.

2. The method of claim 1, wherein the act (B) further comprises:
(3) archiving the one or more selected files.

3. The method of claim 2, wherein a plurality of storage allocations are available for archiving files,
wherein the act (E) comprises (4) selecting at least one of the plurality of storage allocations, and
wherein the act (B)(3) comprises archiving the one or more selected files on the at least one selected storage allocation.

4. The method of claim 3, wherein it is less expensive to store the one or more selected files on the at least one selected storage allocation than on the at least portion of the one or more computer-readable media.

5. The method of claim 3, wherein each of the plurality of storage allocations has an associated cost, and
wherein the act (E)(4) comprises selecting the at least one storage allocation based at least in part on the associated costs of the plurality of storage allocations.

6. The method of claim 1, wherein, for each digital file, a stored information set specifies information indicative of a likelihood that the digital file will be requested by a user in the future, and
wherein the act (B)(1) comprises selecting each of the one or more files based, at least in part, on its said information set.

7. The method of claim 6, wherein, for each digital file, the information set specifies an amount of storage space consumed by the digital file.

8. The method of claim 7, further comprising and act of:
(C) each time one of the digital files is modified, updating the information set of the digital file in accordance with the modification.

9. The method of claim 1, wherein the act (B)(1) comprises an act of:
(a) determining which, if any, of the plurality of digital files meet one or more criteria indicative of a low probability that the digital file will be requested by a user in the future, the one or more selected digital files including any such determined digital files.

10. The method of claim 9, wherein each of the plurality of digital files are medical files of a respective patient for a health care unit, and wherein the act (B)(1)(a) comprises checking whether at least one of the following criteria is met for each of said plurality of digital files:
i) the patient had at least a threshold number of visits to the health care unit over a particular time period followed by no visits within a particular time period leading up to the current time;
ii) the home zip code of the patient does not match any zip codes in a predetermined proximity to the health care unit;
iii) a particular type of disease code is specified in the medical file for a visit by the patient to the health care unit, the visit followed by no visits by the patient to the heath care facility for at least a particular time period;
iv) a non-diagnosis or non-treatment request is specified in the medical file;
v) a periodic treatment code is specified for a most recent visit by the patient to the health care unit and the visit has concluded; or
vi) a particular time period has elapsed since a first and only visit by the patient to the health care unit.

11. The method of claim 9, wherein the act (B)(1) comprises acts of:
(b) determining that a removal of the one or more digital files determined in the act (B)(1)(a), if any, will not reduce an amount of consumed storage space below the threshold value;
(c) determining an order of at least two of the plurality of digital files that were not determined in the act (B)(1)(a), according to a last time that each of the at least two files was accessed, the order beginning with a most recently accessed file and ending with a least recently accessed file; and
(d) selecting at least one of the at least two digital files for removal based on the order, starting at the beginning of the order.

12. The method of claim 11, wherein the act (B) further comprises an act:
(3) adding to a list the selected at least one digital file and the one or more digital files determined in the act (B)(1)(a), if any,
wherein the act (B)(2) comprises removing the one or more selected digital files based on the list.

13. The method of claim 1, comprising periodically performing the acts (A) and (B).

14. The method of claim 1, comprising performing the acts (A) and (B) in response to a digital file being added to the storage allocation.

15. The method of claim 1, wherein at least one of the plurality of digital files comprises a medical record.

16. The method of claim 15, wherein one or more of the at least one digital file that comprises a medical record comprises one or more digital images.

17. The method of claim 1, wherein the act (B)(1) comprises selecting the one or more digital files for removal based, at least in part, on a usage history of at least the one or more selected digital files.

18. The method of claim 1, wherein the act (B)(1) comprises selecting at least one of the selected one or more digital files irrespective of any other digital files of the plurality of digital files.

19. The method of claim 18, wherein the act (B)(1) comprises selecting at least one of the selected one or more digital files by comparing a value of at least one property for the at least one digital file to a value of the at least one property of one or more others of the plurality of digital files.

20. The method of claim 1, wherein the act (B)(1) comprises selecting at least one of the selected one or more digital files by comparing a value of at least one property of the at least one digital file to a value of the at least one property of one or more other of the plurality of digital files.

21. The method of claim 1, further comprising an act of:
(C) storing the one or more selected digital files on one or more computer-readable media that are separate from the one or more computer-readable media on which the plurality of digital files are stored.

22. The method of claim 1, wherein the act (B) further comprises an act:
(3) adding each selected digital file to a list,
wherein the act (B)(2) comprises removing the one or more selected digital files based on the list.

23. A system for managing storage capacity on at least a portion of one or more computer-readable media having stored thereon a plurality of digital files, comprising:
a storage controller to determine whether an amount of storage space consumed by said plurality of digital files has reached a threshold value, and, if the threshold value has been reached, to:
select one or more digital files of the plurality for removal from said media based, at least in part, on a likelihood that the one or more digital files will be requested by a user in the future and not solely on an amount of time that has elapsed since the one or more digital files was created or last accessed, and
remove the one or more selected digital files from the media.

24. The system of claim 23, wherein the storage controller is operative to archive the one or more selected files if the threshold value has not been reached.

25. The system of claim 24, wherein a plurality of storage allocations are available for archiving files,
wherein the storage controller is operative to select at least one of the plurality of storage allocations, and to archive the one or more selected files on the at least one selected storage allocation.

26. The system of claim 25, wherein it is less expensive to store the one or more selected files on the at least one selected storage allocation than on the at least portion of the one or more computer-readable media.

27. The system of claim 25, wherein each of the plurality of storage allocations has an associated cost, and
wherein the storage controller is operative to select the at least one storage allocation based at least in part on the associated costs of the plurality of storage allocations.

28. The system of claim 23, further comprising:
a data source to store, for each digital file, an information set that specifies information indicative of a likelihood that the digital file will be requested by a user in the future, and
wherein the storage controller is operative to select each of the one or more files based, at least in part, on its said information set.

29. The system of claim 28, wherein, for each digital file, the information set specifies an amount of storage space consumed by the digital file.

30. The system of claim 29, wherein the storage controller is operative to update, each time one of the digital files is modified, the information set of the digital file in accordance with the modification.

31. The system of claim 23, wherein the storage controller is operative to determine which, if any, of the plurality of digital files meet one or more criteria indicative of a low probability that the digital file will be requested by a user in the future, the one or more selected digital files including any such determined digital files.

32. The system of claim 31, wherein each of the plurality of digital files are medical files of a respective patient for a health care unit, and wherein the storage controller is operative to check whether at least one of the following criteria is met for each of said plurality of digital files:
i) the patient had at least a threshold number of visits to the health care unit over a particular time period followed by no visits within a particular time period leading up to the current time;
ii) the home zip code of the patient does not match any zip codes in a predetermined proximity to the health care unit;
iii) a particular type of disease code is specified in the medical file for a visit by the patient to the health care unit, the visit followed by no visits by the patient to the heath care facility for at least a particular time period;
iv) a non-diagnosis or non-treatment request is specified in the medical file;
v) a periodic treatment code is specified for a most recent visit by the patient to the health care unit and the visit has concluded; or
vi) a particular time period has elapsed since a first and only visit by the patient to the health care unit.

33. The system of claim 31, wherein the storage controller is operative to:
determine that a removal of one or more digital files determined to have met the one or more criteria, if any, will not reduce an amount of consumed storage space below the threshold value;
determine an order of at least two of the plurality of digital files that were not determined to have met the one or more criteria, according to a last time that each of the at least two files was accessed, the order beginning with a most recently accessed file and ending with a least recently accessed file; and
select at least one of the at least two digital files for removal based on the order, starting at the beginning of the order.

34. The system of claim 33, wherein the storage controller is operative to add to a list the selected at least one digital file and the one or more digital files determined to have met the one or more criteria, if any, to a list, and to remove the one or more selected digital files based on the list.

35. The system of claim 23, wherein the storage controller is operative to periodically perform the determining and, if it is determined that the threshold has been reached, the selecting and removing.

36. The system of claim 23, wherein the storage controller is operative to perform the determining, and the selecting and removing if it is determined that the threshold has been reached, in response to a digital file being added to the storage allocation.

37. The system of claim 23, wherein at least one of the plurality of digital files comprises a medical record.

38. The system of claim 37, wherein one or more of the at least one digital file that comprises a medical record comprises one or more digital images.

39. The system of claim 23, wherein the storage controller is operative to select the one or more digital files for removal based, at least in part, on a usage history of at least the one or more selected digital files.

40. The system of claim 23, wherein the wherein the storage controller is operative to select at least one of the selected one or more digital files irrespective of any other digital files of the plurality of digital files.

41. The system of claim 40, wherein the storage controller is operative to select at least one of the selected one or more digital files by comparing a value of at least one property for the at least one digital file to a value of the at least one property of one or more others of the plurality of digital files.

42. The system of claim 23, wherein the storage controller is operative to select at least one of the selected one or more digital files by comparing a value of at least one property of the at least one digital file to a value of the at least one property of one or more other of the plurality of digital files.

43. The system of claim 23, wherein the storage controller is operative to control storing the one or more selected digital files on one or more computer-readable media that are separate from the one or more computer-readable media on which the plurality of digital files are stored.

44. The system of claim 23, wherein the storage controller is operative to add each selected digital file to a list, and to remove the one or more selected digital files based on the list.

45. A computer program product comprising:
a computer-readable medium; and
computer-readable signals, stored on the computer-readable medium, that define instructions that, as a result of being executed by a computer, control the computer to perform a process of managing storage capacity on at least a portion of one or more computer-readable media having stored thereon a plurality of digital files, the process comprising acts of:
(A) determining whether an amount of storage space consumed by said plurality of digital files has reached a threshold value; and
(B) if the threshold value has been reached:
(1) selecting one or more digital files of the plurality for removal from said media based, at least in part, on a likelihood that the one or more digital files will be requested by a user in the future and not solely on an amount of time that has elapsed since the one or more digital files was created or last accessed, and
(2) removing the one or more selected digital files from the media.

46. The computer program product of claim 45, wherein the act (B) further comprises:
(3) archiving the one or more selected files.

47. The computer program product of claim 46, wherein a plurality of storage allocations are available for archiving files,
wherein the act (E) comprises (4) selecting at least one of the plurality of storage allocations, and
wherein the act (B)(3) comprises archiving the one or more selected files on the at least one selected storage allocation.

48. The computer program product of claim 47, wherein it is less expensive to store the one or more selected files on the at least one selected storage allocation than on the at least portion of the one or more computer-readable media.

49. The computer program product of claim 47, wherein each of the plurality of storage allocations has an associated cost, and
wherein the act (E)(4) comprises selecting the at least one storage allocation based at least in part on the associated costs of the plurality of storage allocations.

50. The computer program product of claim 45, wherein, for each digital file, a stored information set specifies information indicative of a likelihood that the digital file will be requested by a user in the future, and
wherein the act (B)(1) comprises selecting each of the one or more files based, at least in part, on its said information set.

51. The computer program product of claim 50, wherein, for each digital file, the information set specifies an amount of storage space consumed by the digital file.

52. The computer program product of claim 51, wherein the process further comprises an act of:
(C) each time one of the digital files is modified, updating the information set of the digital file in accordance with the modification.

53. The computer program product of claim 45, wherein the act (B)(1) comprises an act of:
(a) determining which, if any, of the plurality of digital files meet one or more criteria indicative of a low probability that the digital file will be requested by a user in the future, the one or more selected digital files including any such determined digital files.

54. The computer program product of claim 53, wherein each of the plurality of digital files are medical files of a respective patient for a health care unit, and wherein the act (B)(1)(a) comprises checking whether at least one of the following criteria is met for each of said plurality of digital files:
i) the patient had at least a threshold number of visits to the health care unit over a particular time period followed by no visits within a particular time period leading up to the current time;
ii) the home zip code of the patient does not match any zip codes in a predetermined proximity to the health care unit;
iii) a particular type of disease code is specified in the medical file for a visit by the patient to the health care unit, the visit followed by no visits by the patient to the heath care facility for at least a particular time period;
iv) a non-diagnosis or non-treatment request is specified in the medical file;
v) a periodic treatment code is specified for a most recent visit by the patient to the health care unit and the visit has concluded; or
vi) a particular time period has elapsed since a first and only visit by the patient to the health care unit.

55. The computer program product of claim 53, wherein the act (B)(1) comprises acts of:
(b) determining that a removal of the one or more digital files determined in the act (B)(1)(a), if any, will not reduce an amount of consumed storage space below the threshold value;
(c) determining an order of at least two of the plurality of digital files that were not determined in the act (B)(1)(a), according to a last time that each of the at least two files was accessed, the order beginning with a most recently accessed file and ending with a least recently accessed file; and
(d) selecting at least one of the at least two digital files for removal based on the order, starting at the beginning of the order.

56. The computer program product of claim 55, wherein the act (B) further comprises an act:
(3) adding to a list the selected at least one digital file and the one or more digital files determined in the act (B)(1)(a), if any,
wherein the act (B)(2) comprises removing the one or more selected digital files based on the list.

57. The computer program product of claim 45, comprising periodically performing the acts (A) and (B).

58. The computer program product of claim 45, comprising performing the acts (A) and (B) in response to a digital file being added to the storage allocation.

59. The computer program product of claim 45, wherein at least one of the plurality of digital files comprises a medical record.

60. The computer program product of claim 59, wherein one or more of the at least one digital file that comprises a medical record comprises one or more digital images.

61. The computer program product of claim 45, wherein the act (B)(1) comprises selecting the one or more digital files for removal based, at least in part, on a usage history of at least the one or more selected digital files.

62. The computer program product of claim 45, wherein the act (B)(1) comprises selecting at least one of the selected one or more digital files irrespective of any other digital files of the plurality of digital files.

63. The computer program product of claim 62, wherein the act (B)(1) comprises selecting at least one of the selected one or more digital files by comparing a value of at least one property for the at least one digital file to a value of the at least one property of one or more others of the plurality of digital files.

64. The computer program product of claim 45, wherein the act (B)(1) comprises selecting at least one of the one or more digital files by comparing a value of at least one property of the at least one digital file to a value of the at least one property of one or more other of the plurality of digital files.

65. The computer program product of claim 45, wherein the method further comprises an act of:
(C) storing the one or more selected digital files on one or more computer-readable media that are separate from the one or more computer-readable media on which the plurality of digital files are stored.

66. The computer program product of claim 45, wherein the act (B) further comprises an act:
(3) adding each selected digital file to a list,
wherein the act (B)(2) comprises removing the one or more selected digital files based on the list.

67. A method of managing files in a storage area of a file storage facility, the storage area having an available storage capacity, the method comprising acts of:
(A) assigning a unique identifier to each file in the file storage area;
(B) for each file in the file storage area, tracking on a computer the size and content information for the file, using the unique identifier of the file;
(C) for each file in the file storage area, updating the size and content information of the file whenever the information changes;
(D) determining when the cumulative size of all of the files in the file storage area exceeds a threshold percentage of the available storage capacity for the storage area; and
(E) in response to the determination of the threshold being exceeded,
(1) selecting files in the storage area based, at least in part, on a likelihood that the files will be requested by a user in the future and not solely on an amount of time that has elapsed since the files were created or last accessed, and
(2) purging the selected files from the storage area to reduce the cumulative size is below the threshold percentage.

68. The method of claim 67, wherein the storage area is an area of memory on a computer-readable medium, each file is a digital file, and the size of each digital file is an amount of memory consumed by the digital file.

69. The method of claim 67, wherein the storage area is a section of a shelf, each file is a paper file, and the size of each paper file is a thickness of the paper file.

70. The method of claim 67, wherein the act (E) further comprising an act of:
(3) creating a listing of files to be purged.

71. The method of claim 67, wherein the act (E)(1) comprises selecting the files based, at least in part, on the content information of the files in the storage area.

72. The method of claim 67, wherein the act (E)(1) comprises selecting the files based, at least in part, on file usage history for the files in the storage area.

73. The method of claim 67, wherein the act (E)(1) comprises selecting the files based, at least in part, on a size of each of the files in the storage area.

74. The method of claim 67, wherein the act (E)(1) comprises determining which files in the storage area are at least likely to be requested independently of the other files in the storage area.

75. The method of claim 67, wherein the act (E)(1) comprises determining which files in the storage area are least likely to be requested compared with other files in the storage area.

76. The method of claim 67, wherein the act (E)(1) comprises determining which files are least likely to be requested independently of other files in the storage area, and determining which files are least likely to be requested compared with other files in the storage area.

77. The method of claim 67, further comprising acts of:
(F) periodically generating a list of files that may be purged from the storage area; and
(G) printing out the list of files.

78. The method of claim 67, wherein the act (E) further comprises:
(3) moving the purged files to another storage area and/or another storage facility.

79. A system for managing files in a storage area of a file storage facility, the storage area having an available storage capacity, the system comprising:
a unique identifier associated with each file in the file storage area;
a computer;
a database, coupled to the computer, have stored thereon a set of data for each file specifying the size and content information for the file and using the unique identifier of the file;
a storage controller operative to update, for each file, the size and content information of the data set of the file whenever the information changes, to determine whenever a cumulative size for all files within the storage area exceeds a threshold percentage of the available storage capacity for the storage section and, responsive to the determination that the threshold percentage is being exceeded, to:
select files in the storage area based, at least in part, on a likelihood that the files will be requested by a user in the future and not solely on an amount of time that has elapsed since the files were created or last accessed, and
purge the selected files from the storage area to reduce the cumulative size below the threshold percentage.

80. The system of claim 79, wherein the storage area is an area of memory on a computer-readable medium, each file is a digital file, and the size of each digital file is an amount of memory consumed by the digital file.

81. The system of claim 79, wherein the storage area is a section of a shelf, each file is a paper file, and the size of each paper file is a thickness of the paper file.

82. The system of claim 79, wherein the storage controller is operative to create a listing of files to be purged.

83. The system of claim 79, wherein the storage controller is operative to create the list based, at least in part, on the content information for the files in the storage area.

84. The system of claim 79, wherein the storage controller is operative to create the list based, at least in part, on file usage history for the files in the storage area.

85. The system of claim 79, wherein the storage controller is operative to select the files based, at least in part, on the size of each file in the storage area.

86. The system of claim 79, wherein the storage controller is operative to select the files by at least determining which files in the storage area are least likely to be requested, independently of the other files in the storage area.

87. The system of claim 79, wherein the storage controller is operative select the files by at least determining which files in the storage area are least likely to be requested compared with other files in the storage area.

88. The system of claim 79, wherein the storage controller is operative to select the files by at least determining which files in the storage area are least likely to be requested independently of other files in the storage area, and determining which files in the storage area are least likely to be requested compared with other files in the storage area.

89. The system of claim 79, wherein the storage controller is operative to periodically generate a list of files that may be purged from the storage area, and to control a printing out of the list.

90. The system of claim 79, wherein the storage controller is operative to control a moving of the purged files to another storage area and/or another storage facility.
